(19) United States
(12) Patent Application Publication
(10) Pub. No.: US 2024/0163412 A1
(43) Pub. Date: May 16, 2024

(54) INFORMATION PROCESSING APPARATUS, INFORMATION PROCESSING METHOD, AND INFORMATION PROCESSING SYSTEM

(71) Applicants: Tsuyoshi Maehana, KANAGAWA (JP); Haseo Hotta, KANAGAWA (JP); Tomoko Senju, KANAGAWA (JP)

(72) Inventors: Tsuyoshi Maehana, KANAGAWA (JP); Haseo Hotta, KANAGAWA (JP); Tomoko Senju, KANAGAWA (JP)

(73) Assignee: Ricoh Company, Ltd., Tokyo (JP)

(21) Appl. No.: 18/505,615

(22) Filed: Nov. 9, 2023

(30) Foreign Application Priority Data
Nov. 14, 2022 (JP) 2022-182022

(51) Int. Cl. H04N 13/117; G06T 19/00

(52) U.S. Cl. CPC H04N 13/117; G06T 19/00

(57) ABSTRACT

An information processing apparatus includes circuitry to generate a display screen that displays a virtual space corresponding to a viewpoint of a user, and displays, in response to an operation performed by another user, the virtual space corresponding to the viewpoint that is moved to vicinity of another viewpoint of the another user.

### CROSS-REFERENCE TO RELATED APPLICATIONS

This patent application is based on and claims priority pursuant to 35 U.S.C. § 119(a) to Japanese Patent Application No. 2022-182022, filed on Nov. 14, 2022, in the Japan Patent Office, the entire disclosure of which is hereby incorporated by reference herein.

### BACKGROUND

### Technical Field

The present disclosure relates to an information processing apparatus, an information processing method, and an information processing system.

### Related Art

In the related art, a method for providing a virtual space includes the steps of detecting a tilt direction in which a user of a head-mounted display device is tilted, determining a moving direction of the user in the virtual space based on the detected tilt direction, and causing the head-mounted display device to display a field of view of the user in the virtual space. The field of view moves in the determined moving direction of the user.

### SUMMARY

An embodiment of the disclosure includes an information processing apparatus includes circuitry to generate a display screen that displays a virtual space corresponding to a viewpoint of a user, and displays, in response to an operation performed by another user, the virtual space corresponding to the viewpoint that is moved to vicinity of another viewpoint of the another user.

An embodiment of the disclosure includes an information processing method including generating a display screen that displays a virtual space corresponding to a viewpoint of a user, and displays, in response to an operation performed by another user, the virtual space corresponding to the viewpoint that is moved to vicinity of another viewpoint of the another user.

An embodiment of the disclosure includes an information processing system including a first information processing apparatus and a second information processing apparatus communicably connected to the first information processing apparatus. The first information processing apparatus generates a first display screen that displays a first virtual space corresponding to a first viewpoint of a first user, and displays the first virtual space in which an avatar of a second user is moved to vicinity of the first viewpoint in response to an operation performed by the first user. The first information processing apparatus transmits, to the second information processing apparatus, first viewpoint position information that is information on a position of the first viewpoint and instruction information for instructing to move a second viewpoint of the second user to the position of the first viewpoint. The second information processing apparatus receives the first viewpoint position information and the instruction information transmitted from the first information processing apparatus, and generates a second display screen that displays a second virtual space corresponding to the second viewpoint, and displays the second virtual space corresponding to the second viewpoint that is moved to the vicinity of the first viewpoint based on the first viewpoint position information and the instruction information.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of a display system according to some embodiments of the present disclosure;

FIG. 2 is a diagram illustrating an operation device of a controller according to some embodiments of the present disclosure;

FIG. 3 is a diagram illustrating push-in movement according to some embodiments of the present disclosure;

FIG. 4 is a block diagram illustrating a hardware configuration of each of a terminal device and a server according to some embodiments of the present disclosure;

FIG. 5 is a block diagram illustrating a hardware configuration of a head-mounted display (HMD) according to some embodiments of the present disclosure;

FIG. 6 is a block diagram illustrating a functional configuration of a display system according to some embodiments of the present disclosure;

FIG. 7 is a conceptual diagram illustrating a component information management table according to some embodiments of the present disclosure;

FIG. 8A and FIG. 8B are a conceptual diagrams illustrating a viewpoint position information management table and a user information management table, respectively, according to some embodiments of the present disclosure;

FIG. 9 is a sequence diagram illustrating a process for generating an input/output screen according to some embodiments of the present disclosure;

FIG. 10 is a flowchart of a process for a movement operation according to some embodiments of the present disclosure;

FIG. 11 is a sequence diagram illustrating a process for a multiple-participant movement operation according to some embodiments of the present disclosure;

FIGS. 12A and 12B are diagrams each illustrating an input/output screen according to some embodiments of the present disclosure;

FIGS. 13A to 13C are diagrams each illustrating an input/output screen according to some embodiments of the present disclosure;

FIGS. 14A to 14E are diagrams each illustrating an input/output screen according to some embodiments of the present disclosure;

FIG. 15 is a diagram illustrating details of the input/output screen illustrated in FIG. 14E;

FIG. 16 is a flowchart of a process for gathering operation according to some embodiments of the present disclosure; and

FIG. 17 is a sequence diagram illustrating a process for a gathering operation according to some embodiments of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

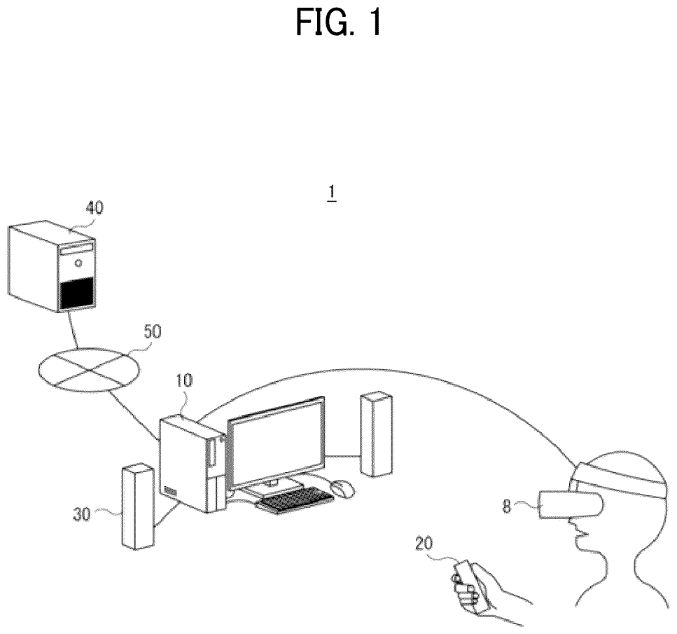

FIG. 1 is a diagram illustrating an overall configuration of a display system according to an embodiment of the present disclosure. A display system 1 according to the present embodiment serves as an information processing system, and includes a head-mounted display (referred to as an HMD in the following description) 8, a terminal device 10, a controller 20, a position detection device 30, and a server 40.

The HMD 8 serves as a display apparatus, the terminal device 10 serves as an information processing apparatus, and the server 40 also serves as an information processing apparatus.

Each of the terminal device 10 and the server 40 may include a single computer or multiple computers, and may be a general-purpose personal computer (PC) in which a dedicated software program is installed.

The terminal device 10 and the server 40 can communicate with each other via a communication network 50. The communication network 50 is implemented by, for example, the Internet, a mobile communication network, or a local area network (LAN). The communication network 50 may include, in addition to wired communication networks, wireless communication networks in compliance with, for example, 3rd generation (3G), Worldwide Interoperability for Microwave Access (WiMAX), or long term evolution (LTE).

The HMD 8, the controller 20, and the position detection device 30 are each connected to the terminal device 10, and can be connected in any connection manner. For example, a dedicated connection line, a wired network such as a wired LAN, or a wireless network using short-range communication such as BLUETOOTH (registered trademark) or WIFI (registered trademark) may be used for connection.

The HMD 8 is mounted on the head of a user, includes a display for displaying an image of a three-dimensional virtual space to the user, and causes the display to display an image corresponding to the position of the HMD 8 or the tilt angle with respect to a reference direction. The three-dimensional virtual space is simply referred to as a virtual space in the following description of embodiments.

Two images corresponding to the left and right eyes is to be used in order to make the images look three-dimensional using binocular disparity of the user. For this reason, the HMD 8 includes two displays for displaying images corresponding to the left and right eyes. The reference direction is, for example, any direction parallel to the floor. The HMD 8 includes a light source such as an infrared light emitting diode (LED) that emits infrared light.

The controller 20 is an operation device held by a hand of the user or worn on a hand of the user and includes, for example, a button, a wheel, or a touch sensor. The controller 20 receives an input from the user and transmits the received information to the terminal device 10. The controller 20 also includes a light source such as an infrared LED that emits infrared light.

The position detection device 30 is disposed at a desired position in front of the user, detects positions and tilts of the HMD 8 and the controller 20 from infrared rays emitted from the HMD 8 and the controller 20, and outputs position information and tilt information. The position detection device 30 may be simply referred to as a detection device 30 in the description of the present embodiment. The position detection device 30 includes, for example, an infrared ray camera to capture images, and can detect the positions and tilts of the HMD 8 and the controller 20 based on the captured image. Multiple light sources are provided in the HMD 8 and the controller 20 in order to detect the positions and tilts of the HMD 8 and the controller 20 with high accuracy. The position detection device 30 includes one or more sensors. In case where multiple sensors are used, the position detection device 30 can be provided with one or more of the multiple sensors on, for example, the side or the rear, in addition to on the front.

Based on the position information of the HMD 8 and the controller 20 and the tilt information of the HMD 8, or the position information of the HMD 8 and the controller 20 and the tilt information of the HMD 8 and the controller 20, which are output from the position detection device 30, the terminal device 10 generates a user object such as an avatar representing the user or a laser for assisting a user input in the virtual space displayed on a display unit of the HMD 8.

Based on the position information and the tilt information of the HMD 8 and virtual space data, the terminal device 10 generates an image in a direction of field of view of the user in the virtual space (more precisely, the tilt direction of the HMD 8) and corresponding to the left and right eyes, and displays the image on a display of the HMD 8.

The terminal device 10 can communicate with the server 40 via the communication network 50, acquire position information of another user in the same virtual space, and execute a process of displaying an avatar representing the other user on the display of the HMD 8.

In this case, each of multiple users sharing the virtual space can share the virtual space with the other user(s) by using a set of the HMD 8, the terminal device 10, the controller 20, and the position detection device 30 and causing the terminal device 10 to communicate with the server 40.

For example, the display system 1 can be used to gather avatars of users who are participants of a conference in a virtual conference room as a virtual space and hold the conference using a whiteboard. The participants of such a conference can actively participate in the conference using whiteboard, so that the display system 1 is useful to hold an interactive conference.

In such a conference using the display system 1, a user can operate the controller 20 to call a function of pen input by, for example, touching a user object in a displayed image, take a displayed pen with his or her hand, move the pen, and input characters on the whiteboard. This is one mode of use, and the present disclosure is not limited to this mode of use.

In the example illustrated in FIG. 1, each of the HMD 8 and the controller 20 includes a light source, and the position detection device 30 is disposed at a desired position. However, this is not limiting, and each of the HMD 8 and the controller 20 may include the position detection device 30, and a light source or a marker that reflects infrared rays may be disposed at a desired position.

In case where the marker is used, each of the HMD 8 and the controller 20 is provided with the light source and the position detection device 30, the infrared ray emitted from the light source is reflected by the marker, and the reflected infrared ray is detected by the position detection device 30. Accordingly, each of the positions and tilts of corresponding one of the HMD 8 and the controller 20 can be detected.

When an object is present between the position detection device 30 and the HMD 8 or the controller 20, the infrared rays are blocked, and detection of the position or the tilt is not accurately or is not successfully performed. To deal with this, operations and displays performed using the HMD 8 and the controller 20 are preferably performed in an open space.

In the example illustrated in FIG. 1, a space in which the user wearing the HMD 8 on his or her head and holding the controller 20 in his or her hand can stretch or extend his or her arms is provided, and the terminal device 10 and the position detection devices 30 are disposed outside the space.

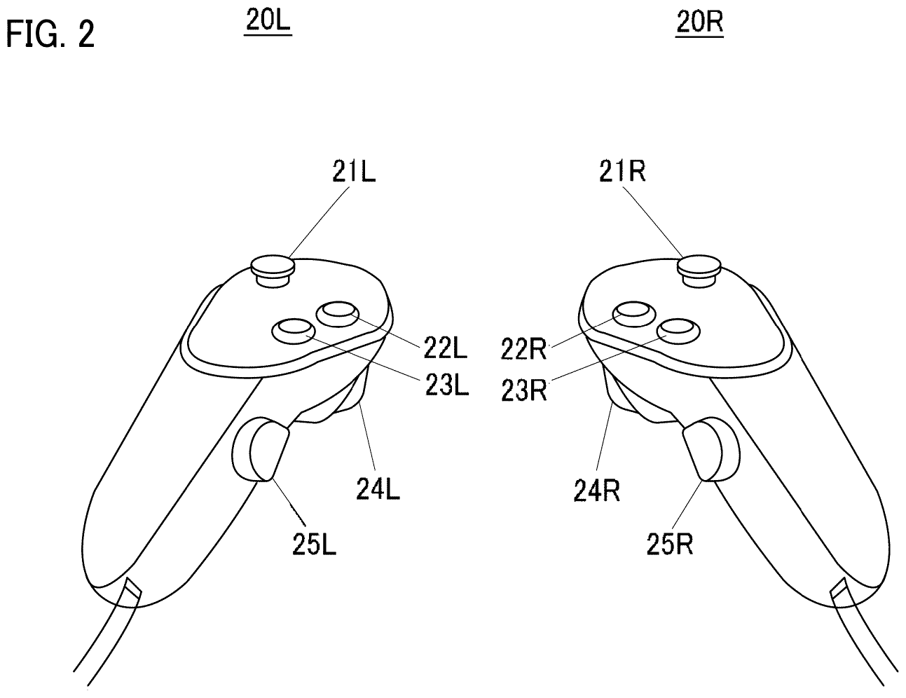

FIG. 2 is a diagram illustrating an operation device of the controller 20 according to the present embodiment.

The controller 20 includes a right controller 20R and a left controller 20L. The right controller 20R is operated by the right hand of the user. The left controller 20L is operated by the left hand of the user. The right controller 20R and the left controller 20L are configured symmetrically as separate devices. This allows the user to freely move each of the right hand holding the right controller 20R and the left hand holding the left controller 20L. In some embodiments, the controller 20 is an integrated controller that can receive operations by both hands.

The right controller 20R and the left controller 20L include thumbsticks 21R and 21L, triggers 24R and 24L, and grips 25R and 25L, respectively.

The right controller 20R includes a B button 22R and an A button 23R, and the left controller 20L includes a Y button 22L and an X button 23L.

A menu displayed in a virtual space is operable by the user for settings with a specific trigger or button of the right controller 20R or the left controller 20L. The menu displayed in the virtual space is operable by the user for inputting information to select three-dimensional data or for setting a hidden mode or a transparency mode, which is described later.

The viewpoint of the user in the virtual space displayed on the display of the HMD 8 is moved in response to an operation performed by the user with the right controller 20R or the left controller 20L. Specific examples of movement of the viewpoint of the user according to operations performed with the controller 20 are described below.

### Laser-Point Movement

Laser-point movement is typically used to move the viewpoint of the user from a current position to a position at a long distance in the virtual space.

When the user extends his or her arm to put his or her hand holding the right controller 20R or the left controller 20L far from the center of the body of the user, the right controller 20R or the left controller 20L is detected by the position detection device 30, and a laser emitted from the hand of the avatar of the user is displayed in the virtual space.

When the user shines the laser on the floor, a marker object is displayed. When the trigger 24R of the right controller 20R or the trigger 24L of the left controller 20L is pressed for a movement operation while the marker object is being displayed, the viewpoint of the user moves to the position of the marker object. Details of the movement are described later.

At this time, a peripheral edge of an image represented by image data and viewed with the HMD 8 is slightly darkened (faded to black) or the entire screen is darkened (faded to black). In other words, the sickness caused by the movement of the viewpoint is reduced by fading to black. Fading to black specifically refers to processing of reducing brightness (luminance) by displaying the entire or a part of the screen in black or displaying the screen in black in which a part of the background is visible.

For example, the display system 1 executes the following process related to the laser-point movement.

First, position information and tilt of the HMD 8 or the controller 20 are estimated by the position detection device 30.

Subsequently, with the position of the controller 20 as a starting point, a laser having a specific length is placed in a specific direction in the virtual space. The specific direction is, for example, a tilt direction of the controller 20. The specific length is, for example, a length determined by a method of determining a length according to a distance between an estimated position of the shoulder and the position of the controller 20, which is described, for example, in Japanese Unexamined Patent Application Publication No. 2022-078778.

Subsequently, whether the placed laser can be moved onto an object in the virtual space through which the laser passes is checked, and when the laser can be moved, a movement-destination point is determined. The determination method is described later.

When it is determined that there is a movement destination, a possible-movement-destination flag indicating that movement is possible is set to notify the user that movement is possible. For example, a marker object indicating a movement destination to which the movement is possible is displayed at the movement-destination point.

Subsequently, in the virtual space, based on the position information and the tilt information of the HMD 8, image data representing an image of a direction of field of view to which the tilt with the position coordinates of the HMD 8 as the center is applied is generated.

When it is determined that there is no movement destination, the possible-movement-destination flag is deleted, and image data is generated in substantially the same manner as described above.

When the user indicates an intention to move by, for example, pressing a button of the controller 20 in a state where the possible-movement-destination flag is set, the movement to the movement-destination point is performed.

In case of such movement, if a sudden visual change caused by instantaneous movement is given to the user, the user can easily get sick. To deal with this, the image data to be viewed with the HMD 8 is changed from an image of the direction of field of view to which the tilt with the position coordinates of the HMD 8 as the center is applied based on the position information and the tilt information of the HMD 8 in the virtual space by a method in the following description in order to give an effect similar to blinking and give a margin for adapting to the visual change.
Fading out by gradually darkening the image data before the movement.
Completely darkening the image data during the movement.
Fading in the image data to be the previous state after the movement.

In the movement, the viewpoint of the user is arranged above the ground on which the user stands by the height of the HMD 8 that is estimated or set in advance from the coordinates of the movement point in the virtual space.

The movement-destination point is determined by checking that a horizontal plane on which the user can stand is present at the intersection of the laser and a specific object by a method described below. Further, by investigating whether movement can be performed with respect to a specific object closer to the laser, even if there is an obstacle such as a wall between the user and the movement-destination point, the movement can be performed. The specific object is an object, such as a building or a landform in the virtual space, to which the movement can be performed.

First, for a specific object that is closest to the controller 20 and through which the laser passes, a specific polygon is selected from among a set of polygons constituting the object. The polygon is a surface of a polygon such as a triangle or a quadrangle, and the specific polygon is a polygon that is closest to the controller 20 and through which the laser passes.

When there is no object through which the laser passes, the determination indicates that there no movement destination, and the investigation is ended.

Subsequently, an angle formed by an inner product of a normal vector of the specific polygon and an upward vector of the virtual space is calculated. The normal of a polygon is a vector in a direction perpendicular to the front-facing surface.

When the formed angle is within a fixed range, the specific polygon is determined as being a horizontal plane, and the movement-destination point is determined as a point at which the laser and the specific polygon intersects with each other, resulting in determination indicating that the movement can be performed, and the investigation is ended.

When the formed angle is out of the fixed range, the object is not to be the movement destination, and the investigation is repeatedly continued with respect to another specific object that is, for example, the next closest to the controller 20 and through which the laser passes, in substantially the same manner, by checking whether the specific polygon is a horizontal plane, and whether the movement can be performed.

When there is no specific polygon that is a horizontal plane in all the specific objects through which the laser passes, it is determined that there is no movement destination and the investigation is ended.

### Transparent Movement

Transparent movement is a type of laser-point movement, and is typically used to shift the viewpoint of the user from a current position to a position behind a structure such as a wall in virtual space.

When the user extends his or her arm to put his or her hand holding the right controller 20R or the left controller 20L far from the center of the body of the user, the right controller 20R or the left controller 20L is detected by the position detection device 30, and a laser emitted from the hand of the avatar of the user in the virtual space is displayed.

When the user shines the laser on a wall, the wall is temporarily not displayed or is displayed in a penetrable manner, or transparently.

When the user shines the laser on the floor behind the wall that is not displayed or that is displayed transparently, a marker object is displayed. When the trigger 24R of the right controller 20R or the trigger 24L of the left controller 20L is pressed while the marker object is being displayed, the viewpoint of the user moves to the position of the marker object.

At this time, a peripheral edge of an image represented by image data and viewed with the HMD 8 is slightly darkened (faded to black) or the entire screen is darkened (faded to black). In other words, the sickness caused by the movement of the viewpoint is reduced by fading to black.

The transparent movement is described below in detail.

The transparent movement is a mode in which all specific objects through which the laser passes between the controller position in the virtual space and the object having the horizontal plane to the movement destination in the laser-point movement are temporarily not displayed. By so doing, the movement-destination point can be visually checked.

This allows the user to check where the movement destination is when moving inside of a building in which multiple objects such as walls obstructing a field of view are present. Further, the user can easily get sick in a narrow space with a sense of constriction such as a space having walls on the left and right in the virtual space. With the transparent movement mode, a desired object is penetrable, and this reduces the sense of constriction that the user can feel, and this can prevent the user from getting sick. The user can select a mode between the mode in which a wall is impenetrable or the transparent movement mode, by using an operation interface (IF). The specific object is an object, such as a building or a landform in the virtual space, to which the movement can be performed.

For example, the display system 1 executes the following process related to the transparent movement.

First, a movement-destination point in the laser-point movement is obtained.

When there is a movement-destination point, all the specific objects through which the laser object passes up to the point are listed, and when there is no movement-destination point, all the specific objects through which the laser object passes are listed.

Subsequently, transparency display is performed for each of the listed objects, or each of the listed objects is hidden. When a certain period of time has not elapsed from a start time for the transparent, the object is made be transparent.

When a certain period of time has not elapsed from a time at which the laser object does not pass through the listed objects when being moved, the objects are displayed again.

### Forward Movement

Forward movement is typically used to move the viewpoint of the user from a current position to a position at a short distance in the virtual space.

When the thumbstick 21R of the right controller 20R or the thumbstick 21L of the left controller 20L is tilted forward by the user, the viewpoint of the user instantaneously moves forward by a certain distance in the direction in which the HMD 8 faces. The “direction in which the HMD 8 faces” at this time includes both of horizontal-direction components and vertical-direction components. Accordingly, for example, when the HMD 8 is directed slightly upward from the horizontal direction, the viewpoint of the user moves obliquely upward and forward, and the position of the viewpoint at the movement destination is higher than the position before the movement.

### Backward Movement

Backward movement is typically used to move the viewpoint of the user from a current position to a position at a short distance in the virtual space.

When the thumbstick 21R of the right controller 20R or the thumbstick 21L of the left controller 20L is tilted backward by the user, the viewpoint of the user instantaneously moves backward by a certain distance in the direction in which the HMD 8 faces. The “direction in which the HMD 8 faces” at this time includes horizontal-direction components, but does not include vertical-direction components. Accordingly, for example, even when the HMD 8 is directed slightly upward from the horizontal direction, the position of the viewpoint at the movement destination has the same height as the position before the movement, and the viewpoint does not move obliquely downward and backward.

Further, the movement amount in the backward movement is shorter than the movement amount in the forward movement. Accordingly, even when the forward movement and the backward movement are repeated, the same position is not reciprocated, and the position can be easily adjusted according to an operation by the user.

### Horizontal Rotation

When the thumbstick 21R of the right controller 20R or the thumbstick 21L of the left controller 20L is tilted right or left by the user, the viewpoint of the user instantaneously rotated horizontally.

For example, tilting the thumbstick 21R or 21L to the left results in an instantaneous horizontal rotation of the viewpoint of the user by 45 degrees to the left, and tilting the thumbstick 21R or 21L to the right results in an instantaneous horizontal rotation of the viewpoint of the user by 45 degrees to the right.

Accordingly, the user can see the left, right, and rear fields of view without rotating his or her body to the left or right.

Further, fine rotation may be performed by using a specific button such as the grip 25R or 25L in accordance with the level of the operation skill of the user. For example, by operating the thumbstick 21R or 21L while pressing a specific button with the same hand, fine adjustment for the amount of rotation, such as half rotation (22.5 degrees), can be performed.

### Upward Movement

When the B button 22R of the right controller 20R or the Y button of the left controller 20L is pressed by the user, the viewpoint of the user instantaneously moves upward by a certain distance. The moving direction is the positive Z-axis direction orthogonal to the ground in the virtual space, and is unchanged regardless of the direction in which the HMD 8 faces.

### Downward Movement

When the A button 23R of the right controller 20R or the X button 23L of the left controller 20L is pressed by the user, the viewpoint of the user instantaneously moves downward by a certain distance.

The moving direction is the negative Z-axis direction orthogonal to the ground in the virtual space, and is unchanged regardless of the direction in which the HMD 8 faces.

Further, the movement amount in the downward movement is shorter than the movement amount in the upward movement. Accordingly, even when the upward movement and the downward movement are repeated, the same position is not reciprocated, and the position can be easily adjusted according to an operation by the user.

### Push-in Movement

When the thumbstick 21R of the right controller 20R or the thumbstick 21L of the left controller 20L is pushed down from above by the user, the viewpoint of the user instantaneously moves to a position having contact with the ground directly below.

In a method of calculating a movement destination, first, a position at which an object in the virtual space closest to the user is intersected when the position of the user at the time when the thumbstick 21R or 21L is pushed down from above is extended in the negative Z-axis direction orthogonal to the ground in the virtual space is obtained.

A position shifted upward from the obtained position by the height of the HMD 8 from the ground on which the user is standing, which is estimated or set in advance, is the movement destination of the viewpoint of the user.

By performing the push-in movement, the viewpoint at the actual height can be instantaneously and easily checked, unlike the upward movement or the downward movement.

### Grip Movement

When the user moves the right controller 20R and the left controller 20L in a state where the grips 25R and 25L of the right controller 20R and the left controller 20L are pressed at the same time for a grip movement operation, the viewpoint of the user is moved parallel to up, down, left, right, front, and back.

The viewpoint of the user continuously moves with reference to the position of both hands at the time when the grip 25R of the right controller 20R and the grip 25L of the left controller 20L are simultaneously started to be pressed with a mental picture in which the virtual space is held and moved by both hands.

Unlike the other movement methods, the viewpoint of the user is not instantaneously moved by a fixed distance, but is continuously moved. Accordingly, fine position adjustment is performable by the user.

When the viewpoint of the user continuously moves, sickness due to vection is likely to occur. To deal with this, in the parallel movement, a peripheral edge of the image viewed with the HMD 8 is slightly darkened, in other words, faded to black to reduce the sickness.

Further, the operation of the grip movement can be switched between valid and invalid in accordance with the level of the operation skill of the user.

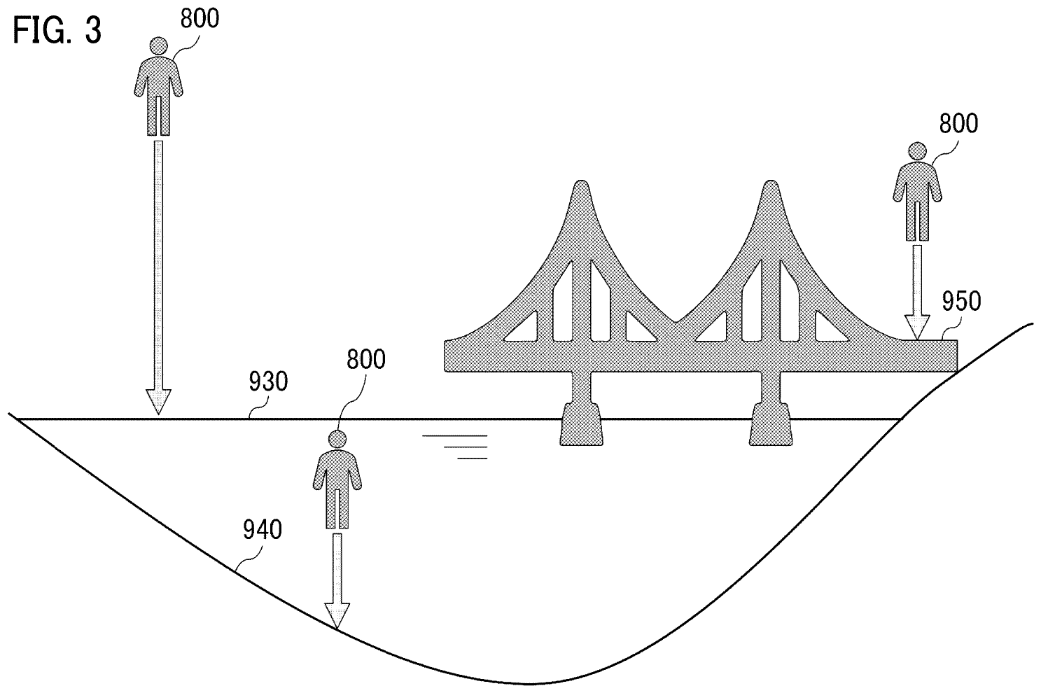

FIG. 3 is a diagram illustrating a virtual space in which a water surface 930, a landform 940, and a building 950 are arranged and how the push-in movement is performed is indicated according to the present embodiment.

As described above with reference to FIG. 2, when the thumbstick 21R of the right controller 20R or the thumbstick 21L of the left controller 20L is pushed down from above by the user, the viewpoint of the user instantaneously moves to a position having contact with an object that locates directly below and that is the closest object to the user.

As illustrated in FIG. 3, an avatar 800 of the user moves to a position having contact with the building 950 when the building 950 is the closest object and locates directly below, to a position having contact with the water surface 930 when the water surface 930 is the closest object and locates directly below, and to a position having contact with the landform 940 when the landform 940 is the closest object and locates directly below.

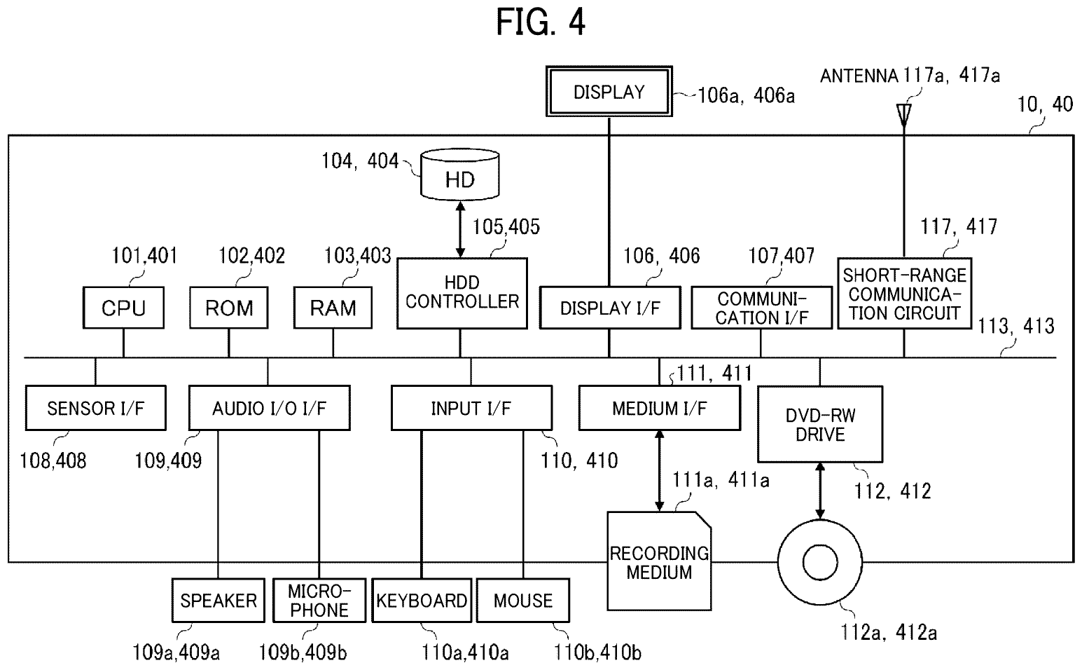

FIG. 4 is a block diagram illustrating a hardware configuration of each of the terminal device and the server according to the present embodiment. Each of components of the hardware configuration of the terminal device 10 is denoted by a reference numeral in the 100 series. Each of components of the hardware configuration of the server 40 is denoted by a reference numeral in 400 series.

Each hardware component of the terminal device 10 is described below. Since each hardware component of the server 40 is substantially the same as that of the terminal device 10, the redundant description is omitted.

The terminal device 10 is implemented by a computer and, as illustrated in FIG. 4, includes a central processing unit (CPU) 101, a read only memory (ROM) 102, a random access memory (RAM) 103, a hard disk (HD) 104, a hard disk drive (HDD) controller 105, a display interface (I/F) 106, and a communication I/F 107.

The CPU 101 performs overall control of the operation of the terminal device 10. The ROM 102 stores a program used for driving the CPU 101, such as an initial program loader (IPL). The RAM 103 is used as a work area for the CPU 101.

The HD 104 stores various data such as a program. The HDD controller 105 controls reading or writing of various data from or to the HD 104 under the control of the CPU 101. The display I/F 106 is a circuit to control a display 106a to display an image. The display 106a serves as a type of display such as a liquid crystal display or an organic electro luminescence (EL) display that displays various types of information such as a cursor, a menu, a window, characters, or an image. The communication I/F 107 is an interface used for communication with another device (external device). The communication I/F 107 is, for example, a network interface card (NIC) in compliance with transmission control protocol/internet protocol (TCP/IP).

The terminal device 10 further includes a sensor I/F 108, a sound input/output I/F 109, an input I/F 110, a medium I/F 111, and a digital versatile disk rewritable (DVD-RW) drive 112.

The sensor I/F 108 is an interface that receives detected information via a sensor amplifier 302 included in the detection device 30. The sound input/output I/F 109 is a circuit that processes the input of sound signals from a microphone 109b and the output of sound signals to a speaker 109a under the control of the CPU 101. The input I/F 110 is an interface for connecting an input device to the terminal device 10.

A keyboard 110a serves as an input device and includes multiple keys for inputting characters, numerals, or various instructions. A mouse 110b serves as an input device for selecting or executing various types of instructions, selecting a subject to be processed, or moving a cursor.

The medium I/F 111 controls reading or writing (storing) of data from or to a recording medium 111a such as a flash memory. The DVD-RW drive 112 controls reading or writing of various data from or to a DVD-RW 112a that serves as a removable recording medium. The removable recording medium is not limited to the DVD-RW and may be a DVD-recordable (DVD-R). Further, the DVD-RW drive 112 may be a BLU-RAY drive to control reading or writing of various data from or to a BLU-RAY disc.

The terminal device 10 further includes a bus line 113. The bus line 113 includes an address bus and a data bus. The bus line 113 electrically connects the components, such as the CPU 101, with each another.

The above-mentioned programs may be stored in a recording medium, such as an HD and a compact disc read-only memory (CD-ROM), to be distributed domestically or internationally as a program product. For example, the terminal device 10 executes a program according to the present embodiment to implement an information processing method according to the present embodiment.

The terminal device 10 further includes a short-range communication circuit 117. The short-range communication circuit 117 is a communication circuit that communicates in compliance with the near field communication (NFC) or the BLUETOOTH (registered trademark), for example.

The controller 20 also has substantially the same hardware configuration as or a simplified hardware configuration from that of each of the terminal device 10 and the server 40, which is described above. The detection device 30 also has substantially the same hardware configuration as or a simplified hardware configuration from that of each of the terminal device 10 and the server 40, and further includes a sensor or a detection device such as an infrared camera.

### Hardware Configuration of HMD

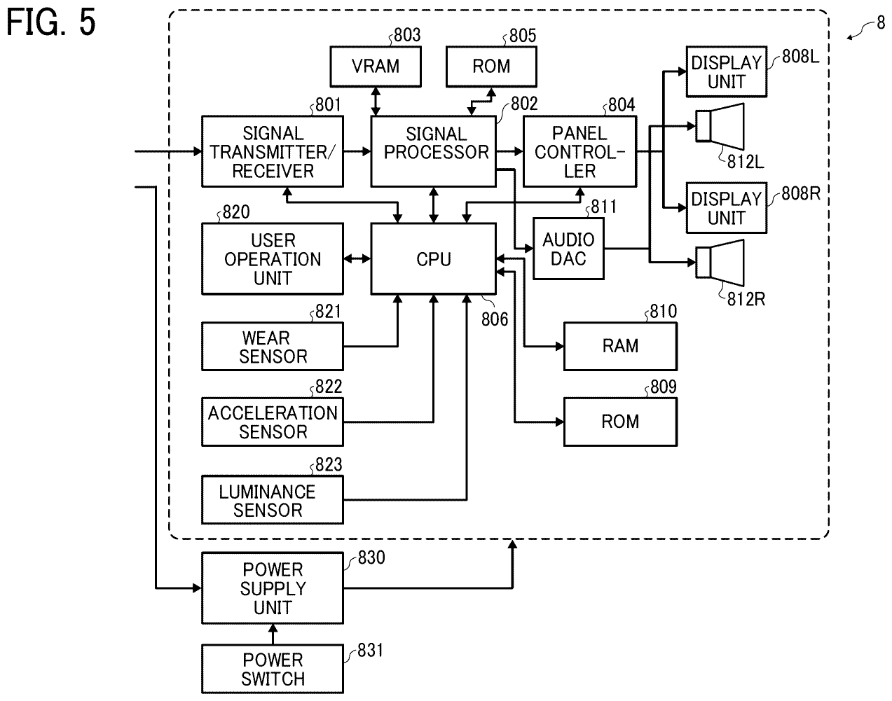

FIG. 5 is a block diagram illustrating a hardware configuration of the HMD according to the present embodiment. The HMD 8 includes a signal transmitter/receiver 801, a signal processor 802, a video random access memory (VRAM) 803, a panel controller 804, a ROM 805, a CPU 806, display units 808R and 808L, a ROM 809, a RAM 810, audio digital to analog converter (DAC) 811, speakers 812R and 812L, a user operation unit 820, a wear sensor 821, an acceleration sensor 822, and a luminance sensor 823. Further, the HMD 8 includes a power supply unit 830 that supplies power and a power switch 831 that can perform or stop power supply of the power supply unit 830.

The signal transmitter/receiver 801 receives an audiovisual (AV) signal and transmits a data signal processed by the CPU 806 (described below) via a cable. In the present embodiment, since the AV signal is transferred in a serial transfer mode, the signal transmitter/receiver 801 performs serial/parallel conversion of the received signal.

The signal processor 802 separates the AV signal received by the signal transmitter/receiver 801 into a video signal and an audio signal and performs video signal processing and audio signal processing on the video signal and the audio signal, respectively.

The signal processor 802 performs image processing such as luminance level adjustment, contrast adjustment, or any other processing for optimizing image quality. Further, the signal processor 802 applies various processing to an original video signal according to an instruction from the CPU 806. For example, the signal processor 802 generates on-screen display (OSD) information including at least one of text and shapes and superimposes the OSD information on the original video signal. The ROM 805 stores a signal pattern used for generating the OSD information, and the signal processor 802 reads out the data stored in the ROM 805.

The OSD information to be superimposed on the original video information is, for example, a graphical user interface (GUI) for adjusting output of a screen and sound. Screen information generated through the video signal processing is temporarily stored in the VRAM 803. When the provided video signal includes stereoscopic video signals including a left video signal and a right video signal, the signal processor 802 separates the video signal into the left video signal and the right video signal to generate the screen information.

Each of the display units 808L and 808R, which are right display unit and left display unit, includes a display panel including organic electroluminescence (EL) elements, a gate driver for driving the display panel, and a data driver. Each of the left and right display units 808L and 808R further includes an optical system having a wide viewing angle. However, the optical system is omitted in FIG. 5.

The menu displayed on the left and right display units 808L and 808R in relation to the virtual space is operable by the user for inputting information to select three-dimensional data or for setting a hidden mode or a transparency mode.

The panel controller 804 reads the screen information from the VRAM 803 at every predetermined display cycle and converts the read screen information into signals to be input to each of the display units 808L and 808R. Further, the panel controller 804 generates a pulse signal such as a horizontal synchronization signal and a vertical synchronization signal used for operation of the gate driver and the data driver.

The CPU 806 executes a program loaded from the ROM 809 into the RAM 810 to perform the entire operation of the HMD 8. Further, the CPU 806 controls transmission and reception of data signals via the signal transmitter/receiver 801.

The main body of the HMD 8 includes the user operation unit 820 including one or more operation elements operable by the user with, for example, his or her finger.

The operation elements are implemented by, for example, a combination of up, down, left, and right cursor keys and an enter key provided in the center of the cursor keys. In the present embodiment, the user operation unit 820 further include a “+” button for increasing the volume of the speakers 812R and 812L and a “−” button for lowering the volume of the speakers 812R and 812L. The CPU 806 instructs the signal processor 802 to perform processing for video output from the display units 808R and 808L, audio output from the left speaker 812L and the right speaker 812R in accordance with a user instruction input via the user operation unit 820. Further, in response to receiving, via the user operation unit 820, an instruction relating to content reproduction such as reproduction, stop, fast forward, or fast rewind, the CPU 806 causes the signal transmitter/receiver 801 to transmit a data signal for notifying the details of the instruction.

Further, in the present embodiment, the HMD 8 includes multiple sensors such as the wear sensor 821, the acceleration sensor 822, and the luminance sensor 823. Outputs from the sensors are input to the CPU 806.

The wear sensor 821 is implemented by, for example, a mechanical switch. The CPU 806 determines whether the HMD 8 is worn by the user, namely, whether the HMD 8 is currently in use, based on an output from the wear sensor 821.

The acceleration sensor 822 includes, for example, three axes, and detects the magnitude and the orientation of the acceleration applied to the HMD 8. The CPU 806 tracks the movement of a head of the user wearing the HMD 8 based on the acquired acceleration information.

The luminance sensor 823 detects the luminance of an environment where the HMD 8 is currently located. The CPU 806 can control luminance level adjustment applied to the video signal based on the luminance information acquired by the luminance sensor 823.

Further, the CPU 806 causes the signal transmitter/receiver 801 to transmit the sensor information acquired from each of the wear sensor 821, the acceleration sensor 822 and the luminance sensor 823.

A power supply unit 830 supplies driving power supplied from a personal computer (PC) to each of the circuit components surrounded by a broken line in FIG. 5. Further, the main body of the HMD 8 includes the power switch 831, which the user can operate with his or her finger. In response to an operation to the power switch 831, the power supply unit 830 switches on and off of power supply to the circuit components.

A state in which the power is off in response to an operation to the power switch 831 corresponds to a “standby” state of the HMD 8, in which the power supply unit 830 is on standby in a power supply state.

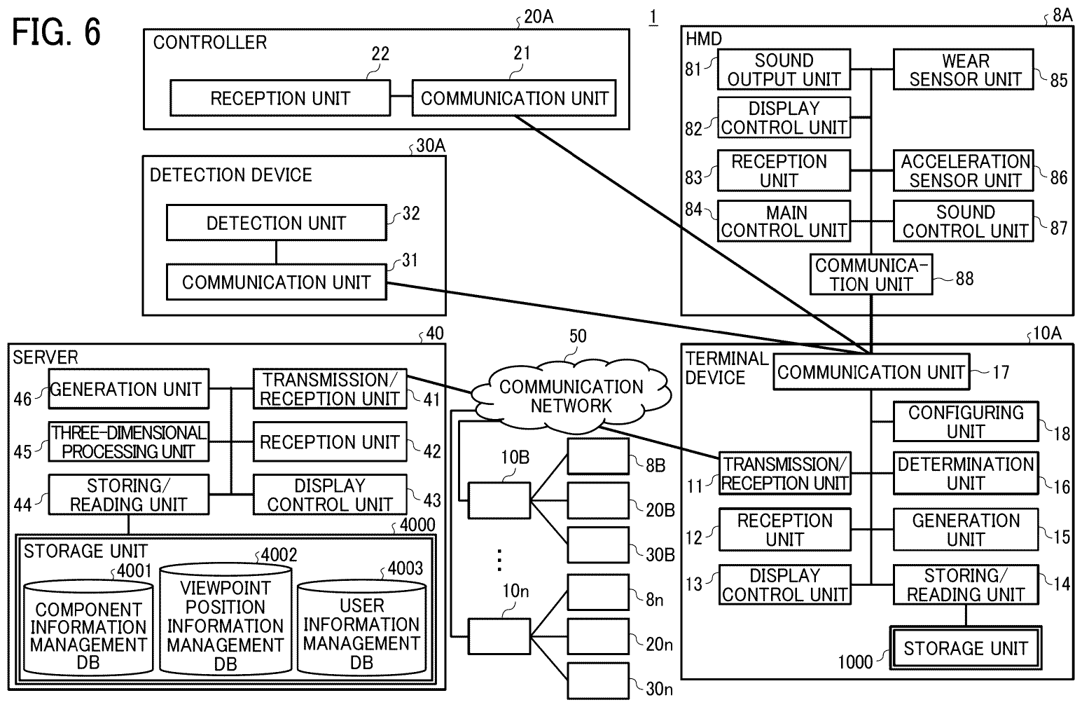

FIG. 6 is a block diagram illustrating a functional configuration of the display system according to the present embodiment.

The display system 1 includes multiple terminal devices 10A, 10B, . . . , and 10n that can communicate with each other via the communication network 50. The display system 1 further includes multiple HMDs 8A, 8B, . . . , and 8n, multiple controllers 20A, 20B, . . . , and 20n, and multiple detection devices 30A, 30B, . . . , and 30n, that are connected to corresponding one of the multiple terminal devices 10A, 10B, . . . , and 10n.

Functional units of the terminal device 10A, the HMD 8A, the controller 20A, and the detection device 30A are described below. Functional units of the terminal device 10B, the HMD 8B, the controller 20B, and the position detection device 30B are substantially the same as that of the terminal device 10A, the HMD 8A, the controller 20A, and the position detection device 30A.

### Functional Configuration of Terminal Device

The terminal device 10A includes a transmission/reception unit 11, a reception unit 12, a display control unit 13, a storing/reading unit 14, a generation unit 15, a determination unit 16, and a communication unit 17. Each of the above-mentioned units is a function that is implemented by or that is caused to function by operation of one or more of the components illustrated in FIG. 4, performed according to an instruction from the CPU 101 according to a program expanded from the HD 104 to the RAM 103.

In the following description of the present embodiment, each functional unit such as the transmission/reception unit 11 is described as the transmission/reception unit 11A when being needed to be distinguished from such as the transmission/reception unit 11B included in the terminal device 10B, otherwise, namely when there is no need to distinguish between the corresponding functional units, the letter such as A is not added to the end.

The terminal device 10A further includes a storage unit 1000 implemented by the RAM 103 and the HD 104 illustrated in FIG. 4. The storage unit 1000 serves as a memory.

The transmission/reception unit 11 has a function of transmitting and receiving various data or information to and from an external device such as the server 40 via the communication network 50. The transmission/reception unit 11 is implemented by, for example, the communication I/F 107 illustrated in FIG. 4 and the execution of a program by the CPU 101 illustrated in FIG. 4. The transmission/reception unit 11 serves as a transmission unit and a reception unit.

The reception unit 12 has a function of receiving user input via an input device such as the keyboard 110a illustrated in FIG. 4. The reception unit 12 is implemented by, for example, the execution of a program by the CPU 101 illustrated in FIG. 4.

The display control unit 13 has a function of causing the display 106a illustrated in FIG. 4 to display various screens. For example, the display control unit 13 causes the display 106a to display a screen related to image data generated in a hypertext markup language (HTML), using a web browser. The display control unit 13 is implemented by, for example, the display I/F 106 illustrated in FIG. 4 and the execution of a program by the CPU 101 illustrated in FIG. 4.

The storing/reading unit 14 has a function of storing various data in the storage unit 1000 or reading various data from the storage unit 1000. The storing/reading unit 14 is implemented by, for example, the execution of a program by the CPU 101 illustrated in FIG. 4.

The storage unit 1000 is implemented by, for example, the ROM 102, the HD 104, and the recording medium 111a, which are illustrated in FIG. 4.

The generation unit 15 has a function of generating various image data to be displayed on the display 106a or the display units 808R and 808L of the HMD 8A. The generation unit 15 is implemented by, for example, the execution of a program by the CPU 401 illustrated in FIG. 4. The generation unit 15 serves as a display screen generation unit.

The determination unit 16 has a function of executing various determinations. The determination unit 16 is implemented by, for example, the execution of a program by the CPU 401 illustrated in FIG. 4.

The communication unit 17 has a function of transmitting and receiving various data or information to and from each of the HMD 8A, the controller 20A, and the detection device 30A. The communication unit 17 is implemented by, for example, the short-range communication circuit 117 illustrated in FIG. 4 and the execution of a program by the CPU 101 illustrated in FIG. 4.

The configuring unit 18 has a function of configuring various settings. The configuring unit 18 is implemented by, for example, the execution of a program by the CPU 401 illustrated in FIG. 4.

### Functional Configuration of Server

The server 40 includes a transmission/reception unit 41, a reception unit 42, a display control unit 43, a storing/reading unit 44, a three-dimensional processing unit 45, and a generation unit 46. Each of the above-mentioned units is a function that is implemented by or that is caused to function by operation of one or more of the components illustrated in FIG. 4, performed according to an instruction from the CPU 401 according to a program expanded from the HD 404 to the RAM 403.

The server 40 further includes a storage unit 4000 implemented by the RAM 403 and the HD 404 in FIG. 4. The storage unit 4000 serves as a memory.

The transmission/reception unit 41 has a function of transmitting and receiving various data or information to and from an external device such as the terminal device 10A via the communication network 50. The transmission/reception unit 41 is implemented by, for example, the communication I/F 407 illustrated in FIG. 4 and the execution of a program by the CPU 401 illustrated in FIG. 4.

The transmission/reception unit 41 serves as a transmission unit and a reception unit.

The reception unit 42 has a function of receiving user input via an input device such as the keyboard 410a illustrated in FIG. 4. The reception unit 42 is implemented by, for example, the execution of a program by the CPU 401 illustrated in FIG. 4.

The display control unit 43 has a function of causing the display 406a illustrated in FIG. 4 to display various screens. For example, the display control unit 43 causes the display 406a to display a screen related to image data generated in an HTML, using a web browser. The display control unit 43 is implemented by, for example, the display I/F 406 illustrated in FIG. 4 and the execution of a program by the CPU 401 illustrated in FIG. 4.

The storing/reading unit 44 has a function of storing various data in the storage unit 4000 or reading various data from the storage unit 4000. The storing/reading unit 44 is mainly implemented by, for example, the execution of a program by the CPU 401 illustrated in FIG. 4.

The storage unit 4000 is implemented by, for example, the ROM 402, the HD 404, and a recording medium 411a, which are illustrated in FIG. 4. The storage unit 4000 includes a component information management database (DB) 4001, a viewpoint position information management DB 4002, and a user information management DB 4003. The component information management DB 4001 includes a component information management table, which is described later.

The three-dimensional processing unit 45 is implemented by, for example, operation of the CPU 401 illustrated in FIG. 4 and has a function of performing three-dimensional processing.

The generation unit 46 has a function of generating various image data to be displayed on the display 406, the display 106a of the terminal device 10A, or the display units 808R and 808L of the HMD 8A. The generation unit 46 is implemented by, for example, the execution of a program by the CPU 401 illustrated in FIG. 4. The generation unit 46 serves as a display screen generation unit.

### Functional Configuration of HMD

The HMD 8A includes a sound output unit 81, a display control unit 82, a reception unit 83, a main control unit 84, a wear sensor unit 85, an acceleration sensor unit 86, a sound control unit 87, and a communication unit 88. Each of the above-mentioned units is a function that is implemented by or that is caused to function by operation of one or more of the components illustrated in FIG. 5, performed according to an instruction from the CPU 806 according to a program for the HMD 8A expanded from the ROM 805 to the VRAM 803 or from the ROM 809 to the RAM 810.

The sound output unit 81 is implemented by, for example, operation of the CPU 806 and the speakers 812R and 812L and conveys sound to the wearer (participant).

The display control unit 82 is implemented by, for example, operation of the CPU 806 and the display units 808R and 808L, and display a selected image.

The display control unit 82 has a function of causing the display units 808R and 808L illustrated in FIG. 5 to display various screens. The display control unit 82 is implemented by, for example, the panel controller 804 illustrated in FIG. 5 and the execution of a program by the CPU 806 illustrated in FIG. 5.

The main control unit 84 is implemented by, for example, the CPU 806.

The reception unit 83 has a function of receiving user input via an input device such as the user operation unit 820 illustrated in FIG. 5. The reception unit 83 is implemented by, for example, the execution of a program by the CPU 806 illustrated in FIG. 5.

The wear sensor unit 85 is implemented by, for example, operation of the CPU 806 and the wear sensor 821 and checks whether the participant is wearing the HMD 8A. The acceleration sensor unit 86 is implemented by, for example, operation of the CPU 806 and the acceleration sensor 822 and detects movement of the HMD 8A.

The sound control unit 87 is implemented by, for example, operation of the CPU 806 and the audio DAC 811 and controls processing of outputting sound from the HMD 8A.

The communication unit 88 has a function of transmitting and receiving various data (or information) to and from the terminal device 10A. The communication unit 88 is implemented by, for example, operation of the CPU 806 and the signal transmitter/receiver 801.

### Functional Configuration of Controller

The controller 20A includes a communication unit 21 and a reception unit 22. Each of the units is a function that is implemented by or that is caused to function by operation of one or more components that are substantially the same components as or simplified components of that of the terminal device or the server illustrated in FIG. 4.

The communication unit 21 has a function of transmitting and receiving various data (or information) to and from the terminal device 10A. The communication unit 21 is implemented by, for example, the substantially same communication circuit as the short-range communication circuit 117 illustrated in FIG. 4.

The reception unit 22 has a function of receiving user input via an input device such as the keyboard 110a illustrated in FIG. 4.

### Functional Configuration of Detection Device

The detection device 30A includes a communication unit 31 and a detection unit 32. Each of the units is a function that is implemented by or that is caused to function by operation of one or more components that are substantially the same components as or simplified components of that of the terminal device or the server illustrated in FIG. 4.

The communication unit 31 has a function of transmitting and receiving various data (or information) to and from the terminal device 10A. The communication unit 31 is implemented by, for example, a program executed by the substantially same communication circuit as the short-range communication circuit 117 illustrated in FIG. 4.

The detection unit 32 has a function of detecting positions and tilts of the HMD 8A and the controller 20A based on output of a sensor or a detection device such as an infrared ray camera.

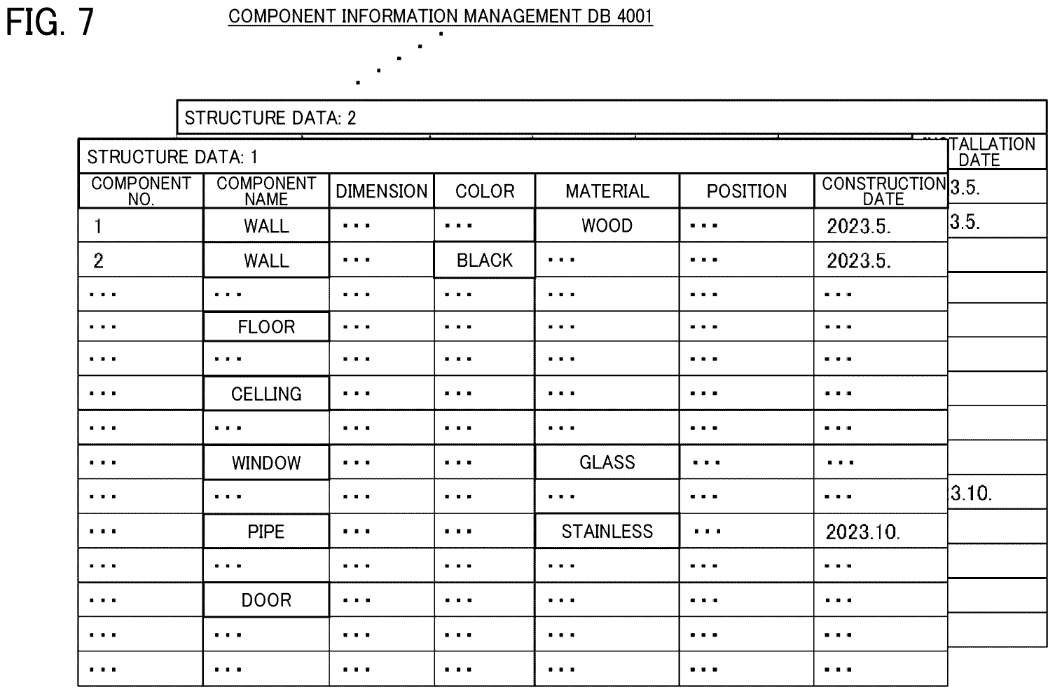

FIG. 7 is a conceptual diagram illustrating a component information management table according to the present embodiment. The component information management table is a table for managing attribute information indicating attributes of components included in a structure included in the virtual space. In the storage unit 4000, a component information management DB 4001 includes a component information management table as illustrated in FIG. 7.

In the example of FIG. 7, the structure is a building, but the structure may be, for example, an organ used for a medical simulation. In such a case, the component information management table manages attribute information indicating attributes of components included in the organ.

In the component information management table, as attribute information, information items of component number (NO), component name information, dimension information, color information, material information, position information, and construction date information are managed in association with each other for each structure data for identifying a structure included in the virtual space.

The component name information is information for identifying a component such as a wall, a floor, a ceiling, a window, a pipe, or a door.

The dimension information is information for identifying a dimension of a component in the virtual space, and is indicated by, for example, numerical values in three-axis directions of XYZ.

The color information is information for identifying color of a component, and the material information is information for identifying a material of a component.

The position information is information for identifying a position of a component in the virtual space, and is indicated by, for example, coordinates in three-axis directions of XYZ. Accordingly, whether multiple components are adjacent to each other can be determined.

The construction date information is information indicating a scheduled date on which the component is to be constructed in the real world. Accordingly, a structure excluding an unconstructed component at a certain point in time can be identified.

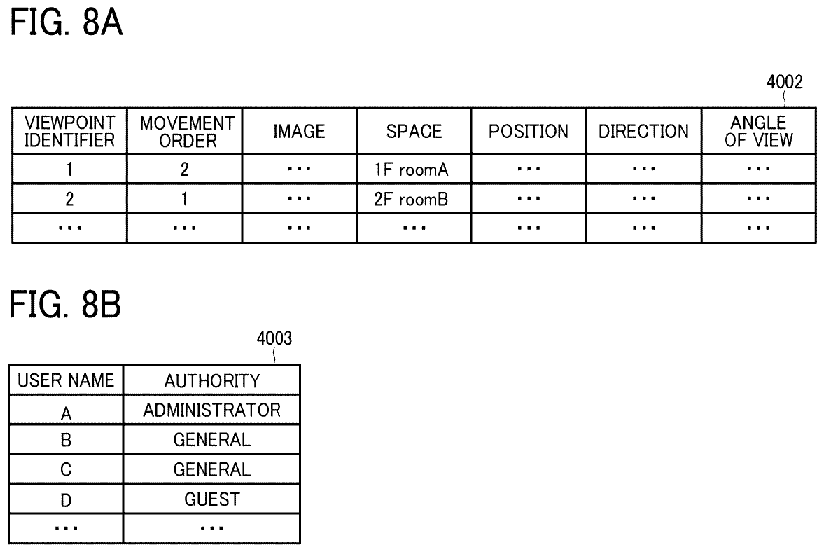

FIG. 8A and FIG. 8B are a conceptual diagrams illustrating a viewpoint position information management table and a user information management table, respectively, according to the present embodiment.

The viewpoint position information management table illustrated in FIG. 8A is a table for managing multiple positions of a viewpoint. In the storage unit 4000, a viewpoint position information management DB 4002 includes a viewpoint position information management table as illustrated in FIG. 8A.

In the viewpoint position information management table, information items of viewpoint identifier, movement order, preview image, space information including a position of the viewpoint, position information, direction information indicating a direction of the viewpoint, and angle-of-view information indicating an angle of view of the viewpoint are managed in association with each other.

As will be described later, causing a viewpoint to sequentially move among multiple position of the viewpoint in the movement order stored in the viewpoint position information management DB 4002 can implement a tour function in a virtual space.

The user information management table illustrated in FIG. 8B is a table for managing user authorities. In the storage unit 4000, a user information management DB 4003 includes a user information management table as illustrated in FIG. 8B.

In the user information management table, authority types such as administrator, general, and guest are managed in association with corresponding user names.

A single movement operation and a multiple-participant movement operation that starts a tour function are performable by a user who has authority as a general user. The single movement operation and the multiple-participant movement operation are described later.

A single movement operation and a multiple-participant movement operation that starts a tour function are not performable by a user who has authority as a guest user. However, the user who has the authority as a guest user can participate in a tour implemented by the tour function started by another user. The single movement operation and the multiple-participant movement operation are described later.

In addition to the operations that are enabled with the authority of general user, a user who has authority of administrator can set and change the authority for each user in the user information management DB 4003.

For example, the user who has the authority of administrator sets the authority of a user who is not familiar with the operations to the authority of guest so that the user who is not familiar with the operations does not perform operations.

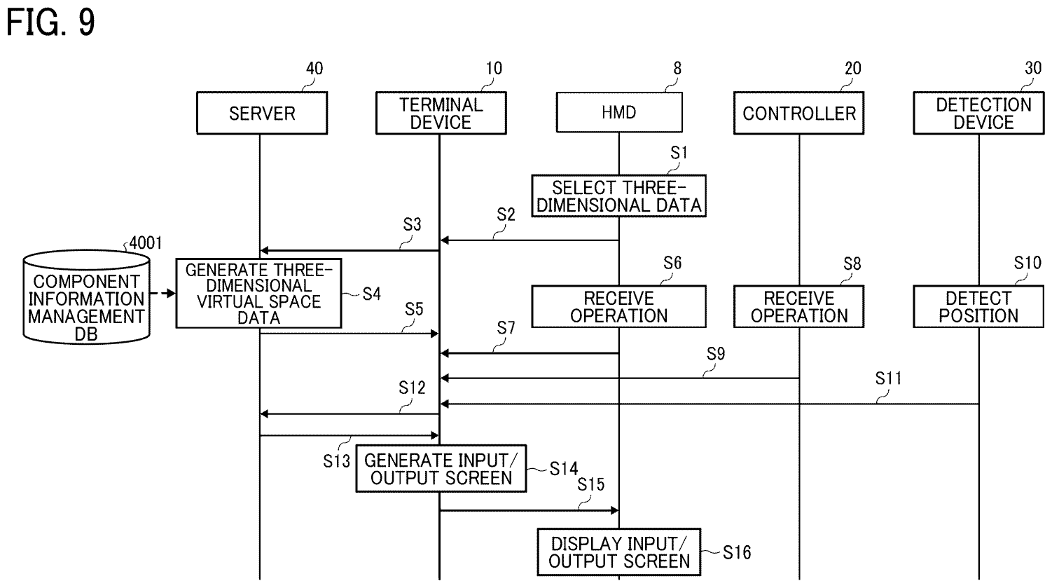

FIG. 9 is a sequence diagram illustrating a process for generating an input/output screen according to the present embodiment.

When information for selecting three-dimensional data is input according to an operation performed by the user using the controller 20 based on image information displayed on the display units 808L and the 808R of the HMD 8 that has been turned on via the user operation unit 820 and worn by the user, the reception unit 83 of the HMD 8 receives the selection (Step S1).

The communication unit 88 transmits selection information for selecting the three-dimensional data to the terminal device 10, and the communication unit 17 of the terminal device 10 receives the selection information transmitted from the HMD 8 (Step S2).

The transmission/reception unit 11 transmits the selection information received from the HMD 8 to the server 40, and the transmission/reception unit 41 of the server 40 receives the selection information transmitted from the terminal device 10 (Step S3).

The storing/reading unit 44 searches the component information management DB 4001 using the selection information received in Step S3 as a search key to read attribute information of a component related to a structure associated with the selection information, and the three-dimensional processing unit 45 generates a virtual space including the structure including the component related to the read attribute information based on the attribute information of the component read by the storing/reading unit 44 (Step S4).

The transmission/reception unit 41 transmits virtual space information indicating the virtual space generated in Step S4 to the terminal device 10, and the transmission/reception unit 11 of the terminal device 10 receives the virtual space information transmitted from the server 40 (Step S5).

The reception unit 83 of the HMD 8 receives various operations performed by the user with respect to the user operation unit 820 (Step S6).

The communication unit 88 transmits operation information indicating the operation received in Step S6 to the terminal device 10, and the communication unit 17 of the terminal device 10 receives the operation information transmitted from the HMD 8 (Step S7).

The reception unit 22 of the controller 20 receives various one or more operations that are performed by the user and described above with reference to FIG. 2 (Step S8).

The communication unit 21 transmits operation information indicating the operation received in Step S8 to the terminal device 10, and the communication unit 17 of the terminal device 10 receives the operation information transmitted from the controller 20 (Step S9).

The detection unit 32 of the detection device 30 detects the positions and the tilts of the HMD 8 and the controller 20 (Step S10).

The communication unit 31 transmits detection information indicating the information detected in Step S10 to the terminal device 10, and the communication unit 17 of the terminal device 10 receives the detection information transmitted from the detection device 30 (Step S11).

The transmission/reception unit 11 of the terminal device 10 transmits the operation information received from the HMD 8 in Step S7, transmits the operation information received from the controller 20 in Step S9, and transmits the detection information received from the detection device 30 in Step S11, to the server 40, and the transmission/reception unit 41 of the server 40 receives the information transmitted from the terminal device 10 (Step S12). Subsequently, the transmission/reception unit 41 of the server 40 transmits the information received from the terminal device 10 to another terminal device.

When receiving information corresponding to the information received in Step S12 from another terminal device, the transmission/reception unit 41 of the server 40 transmits the received information to the terminal device 10, and the transmission/reception unit 11 of the terminal device 10 receives the information transmitted from the server 40 (Step S13).

The generation unit 15 of the terminal device 10 generates an input/output screen that displays the virtual space including the structure based on the virtual space information received in Step S5, the operation information received in Step S7, the operation information received in Step S9, the detection information received in Step S11, and the information received in Step S13 (Step S14). The processing of Step S14 corresponds to a step of generating a display screen.

The communication unit 17 of the terminal device 10 transmits input/output screen information representing the input/output screen generated in Step S14 to the HMD 8, and the communication unit 88 of the HMD 8 receives the input/output screen information transmitted from the terminal device 10 (Step S15).

The display control unit 82 causes the display units 808R and 808L to display the input/output screen represented by the input/output screen information received in Step S15 (Step S16). The processing of Step S16 corresponds to a step of displaying.

In the process described above, the generation unit 46 of the server 40 may execute processing similar to or same as the processing of Step S14, in alternative to the generation unit 15 of the terminal device 10.

In the case where the generation unit 46 of the server executes the processing of Step S14, the generation unit 46 of the server 40 generates the input/output screen that displays the virtual space including the structure based on the virtual space generated in Step S4, the various types of information received in Step S12, and the information received from the other terminal in Step S13.

Subsequently, the transmission/reception unit 41 of the server 40 transmits the input/output screen information representing the generated input/output screen to the terminal device 10, and the communication unit 17 of the terminal device 10 transmits the input/output screen information received from the server 40 to the HMD 8 in substantially the same manner as in Step S15.

Further, the above-described processing can be executed in substantially the same manner even when the HMD 8, the controller 20, and the detection device 30 are not connected to the terminal device 10.

The terminal device 10 detects whether the HMD 8, the controller 20, and the detection device 30 are connected, and when determining the devices are not connected, the terminal device 10 automatically selects a “terminal-screen mode” and executes the process.

In substantially the same manner as in Step S1, when information for selecting three-dimensional data is input according to an operation performed by the user using, for example, the keyboard 110a or the mouse 110b, the reception unit 83 of the terminal device 10 with the “terminal-screen mode” receives the selection.

Further, in substantially the same manner as in Step S14, the generation unit 15 generates an input/output screen that displays the virtual space including the structure based on the virtual space information received in Step S5, the input information according to the operation using, for example, the keyboard 110a or the mouse 110b, and the information received in Step S13.

Subsequently, in substantially the same manner as in Step S16, the display control unit 13 displays the generated input/output screen on the display 116a of the terminal device 10. The input/output screen displayed on 808L and 808R of the HMD 8 are the first person viewpoint at all times, but the input/output screen displayed on the display 116a of the terminal device 10 can be switched between the third person viewpoint and the first person viewpoint by, for example, an operation performed using the keyboard 110a or the mouse 110b.

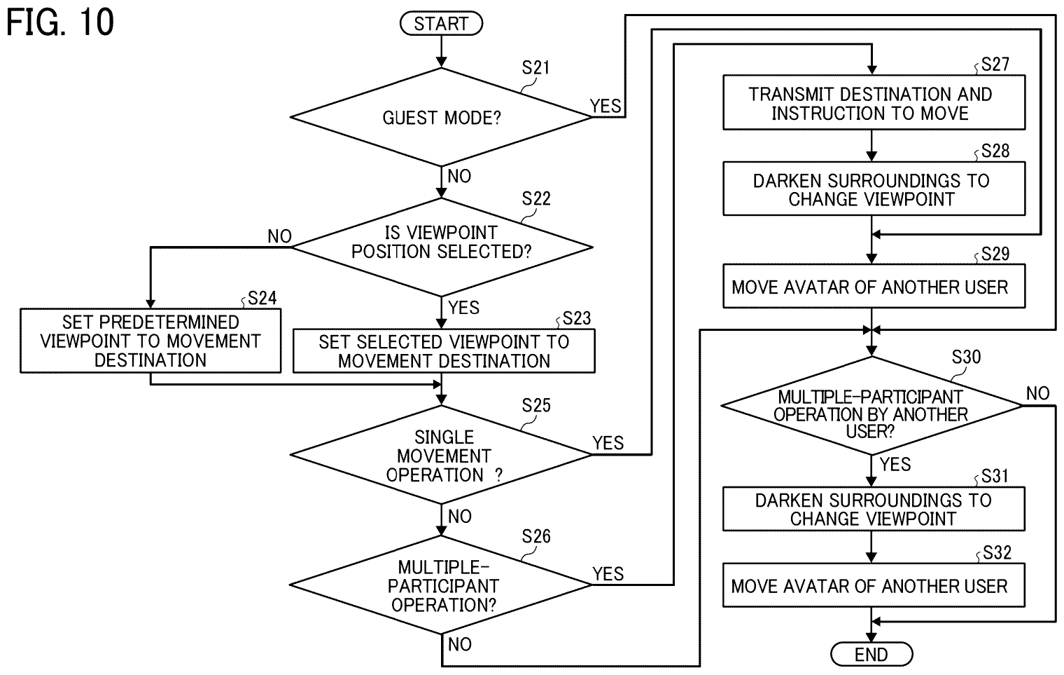

FIG. 10 is a flowchart of a process for a movement operation according to the present embodiment.

The determination unit 16 of the terminal device 10 determines whether the authority of the user is guest based on the user information stored in the user information management DB 4003 (Step S21), and when the authority of the user is guest, the process proceeds to Step S30.

When the authority of the user is not guest in Step S21, the determination unit 16 determines whether a position of the viewpoint is selected using an object in the virtual space, based on the operation information received from the controller 20 by the communication unit 17 and the detection information received from the detection device 30 (Step S22).

Based on the viewpoint position information stored in the viewpoint position information management DB 4002, when a position of the viewpoint is selected, the configuring unit 18 sets the selected position of the viewpoint as a movement destination (Step S23), and when a position of the viewpoint is not selected, the configuring unit 18 sets a predetermined position of the viewpoint as a movement destination (Step S24).

In the description of the present embodiment, the predetermined position of the viewpoint is, for example, a position of the viewpoint corresponding to the first position of the viewpoint in the movement order or corresponding to a next position of the viewpoint after a position of the viewpoint to which the viewpoint is moved last in the movement order, based on the viewpoint position information stored in the viewpoint position information management DB 4002. Accordingly, the tour function for causing the viewpoint to sequentially move among the multiple positions of the viewpoint in the movement order stored in the viewpoint position information management DB 4002 is implemented.

Based on the operation information received from the controller 20 by the communication unit 17 and the detection information received from the detection device 30 by the communication unit 17, the determination unit 16 determines whether a single movement operation has been performed by the user using an object in the virtual space (Step S25), and when it is determined that the single movement operation has been performed, the process proceeds to Step S29.

When it is determined that the single movement operation is not performed in Step S25, the determination unit 16 determines whether a multiple-participant movement operation is performed by the user, based on the operation information received from the controller 20 by the communication unit 17 (Step S26), and when it is determined that the multiple-participant movement operation is not performed, the process proceeds to Step S30.

When it is determined that the multiple-participant movement operation is performed in Step S25, the transmission/reception unit 11 transmits, to the server 40, the viewpoint position information indicating the position of the viewpoint of the user at the movement destination set in Step S23 or S24 and the instruction information instructing to move another viewpoint of another user, or the other one or more viewpoints of the other one or more users, to the vicinity of the viewpoint of the user at the movement destination (Step S27).

Subsequently, the generation unit 15 darkens the surroundings of the viewpoint or the entire screen, and generates an input/output screen corresponding to the viewpoint of the user that is moved to the movement destination set in Step S23 or S24 (Step S28). By so doing, an effect similar to blinking is given to the user, and a margin for adapting to a visual change is given to the user, thereby reducing sickness caused by an instantaneous viewpoint movement.

Further, the generation unit 15 generates the input/output screen that displays the virtual space in which an avatar of the other user, or one or more avatars of the other one or more users, is or are moved to the vicinity of the viewpoint of the user at the movement destination (Step S29). In the description of the present embodiment, the vicinity of the viewpoint of the user at the movement destination may be the same position as the viewpoint of the user at the movement destination, or may be a position having a distance from the viewpoint of the user at the movement destination within a range in which the field of view from the viewpoint of the user at the movement destination can be shared.

Accordingly, the user can cause the viewpoint of the other user, or the one or more viewpoints of the other one or more users, to move to the vicinity of the viewpoint of the user after the movement in the virtual space, and thus can cause the other user, or the other one or more users, to participate in the tour started by the user.

The determination unit 16 determines whether the transmission/reception unit 11 has received additional viewpoint position information indicating a position of a viewpoint at a movement destination of another user and additional instruction information instructing to move the viewpoint of the user to the vicinity of the viewpoint of the other user at the movement destination (Step S30).

When the determination in Step S30 indicates that the information is received, the generation unit 15 darkens the surroundings of the viewpoint or the entire screen, and generates the input/output screen corresponding to the viewpoint of the user that is moved to the vicinity of the position of the viewpoint of the other user at the movement destination received in Step S30 (Step S31).

Further, the generation unit 15 generates the input/output screen that displays the virtual space in which an avatar of the other user is moved to the position of the viewpoint of the other user at the movement destination received in Step S30 (Step S32).

Accordingly, the user can move his or her viewpoint to the vicinity of the viewpoint of the other user after the movement in the virtual space, and thus can participate in a tour started by the other user.

In the above description, the processing of Steps S28, S29, S31, and S32 correspond to a step of generating a display screen.

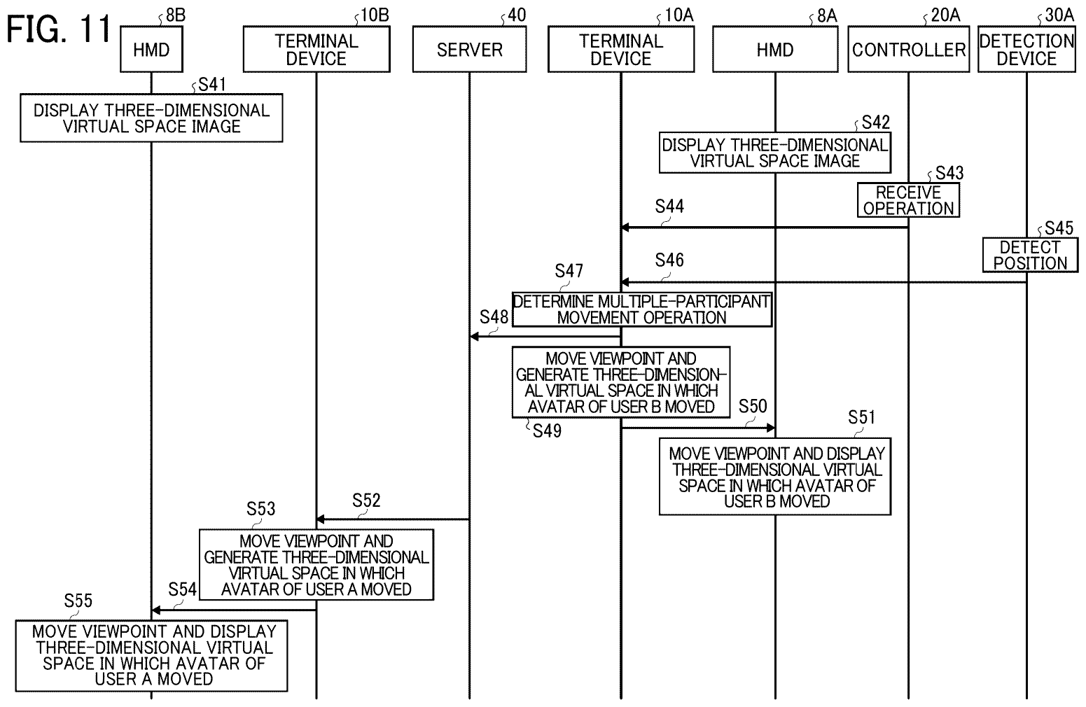

FIG. 11 is a sequence diagram illustrating a process for a multiple-participant movement operation according to the present embodiment.

The display control unit 82B of the HMD 8B used by a user B causes the display units 808RB and 808LB to display an input/output screen that displays a virtual space corresponding to a position of a viewpoint of the user B (Step S41), and the display control unit 82A of the HMD 8A used by a user A also causes the display units 808RA and 808LA to display an input/output screen that displays the virtual space corresponding to a position of a viewpoint of the user A (Step S42). When another user n other than the users A and B also participates in the display system 1, the display control unit 82n of the HMD 8n used by the user n also causes the display units 808Rn and 808Ln to display an input/output screen that displays the virtual space.

The reception unit 22A of the controller 20A used by the user A receives various one or more operations that are performed by the user and described above with reference to FIG. 2 (Step S43).

The communication unit 21A transmits operation information indicating the operation received in Step S43 to the terminal device 10A, and the communication unit 17A of the terminal device 10A receives the operation information transmitted from the controller 20A (Step S44).

The detection unit 32A of the detection device 30A used by the user A detects the positions and tilts of the HMD 8A and the controller 20A (Step S45).

The communication unit 31A transmits detection information indicating the information detected in Step S45 to the terminal device 10A, and the communication unit 17A of the terminal device 10A receives the detection information transmitted from the detection device 30A (Step S46).

The determination unit 16A determines whether a multiple-participant movement operation is performed by the user A, based on the operation information from the controller 20A received by the communication unit 17A (Step S47).

When it is determined that the multiple-participant movement operation is performed in Step S47, the transmission/reception unit 11A transmits, to the server 40, the viewpoint position information indicating the position of the viewpoint of the user A at the movement destination set in Step S23 or S24 in FIG. 10 and the instruction information instructing to move a viewpoint of another user, or the one or more viewpoints of the other one or more users, including the user B to the vicinity of the viewpoint of the user A at the movement destination, and the transmission/reception unit 41 of the server 40 receives the information (Step S48).

As described with reference to FIG. 10, in particular Steps S28 and S29, the generation unit 15A generates the input/output screen that displays the virtual space corresponding to the viewpoint of the user A that is moved to the set movement destination and in which an avatar of the other user, or one or more avatars of the other one or more users, including the user B is or are moved to the vicinity of the viewpoint of the user A at the movement destination (Step S49).

The communication unit 17A of the terminal device 10A transmits input/output screen information indicating the input/output screen generated in Step S49 to the HMD 8A, and the communication unit 88A of the HMD 8A receives the input/output screen information transmitted from the terminal device 10A (Step S50).

The display control unit 82A causes the display units 808RA and 808LA to display the input/output screen represented by the input/output screen information received in Step S50 (Step S51). The processing of Step S51 corresponds to a step of displaying. Further, the transmission/reception unit 41 of the server 40 transmits the viewpoint position information of the user A and the instruction information received from the terminal device 10A in Step S48 to the terminal device 10B used by the user B, and the transmission/reception unit 11B of the terminal device 10B receives the information (Step S52).

When the user n other than the users A and B also participates in the display system 1, the transmission/reception unit 41 of the server 40 transmits the viewpoint position information of the user A and the instruction information received from the terminal device 10A in Step S48 to the terminal device 10n used by the user n, and the transmission/reception unit 11n of the terminal device 10n receives the information.

In substantially the same manner, the transmission/reception unit 41 of the server 40 transmits additional viewpoint position information of the user n and additional instruction information received from the terminal device 10n to the terminal device 10B used by the user B, and the transmission/reception unit 11B of the terminal device 10B receives the information.

As described above with reference to FIG. 10, Steps S31 and S32, the generation unit 15B generates an input/output screen that displays the virtual space corresponding to the viewpoint of the user B that is moved to the vicinity of the viewpoint of the user A at the movement destination and in which an avatar of the user A is moved to the position of the viewpoint of the user A at the movement destination (Step S53).

The communication unit 17B of the terminal device 10B transmits input/output screen information indicating the input/output screen generated in Step S53 to the HMD 8B, and the communication unit 88B of the HMD 8B receives the input/output screen information transmitted from the terminal device 10B (Step S54).

The display control unit 82B causes the display units 808RB and 808LB to display the input/output screen represented by the input/output screen information received in Step S54 (Step S55). The processing of Step S55 corresponds to a step of displaying.

When the user n other than the users A and B also participates in the display system 1, the terminal device 10n and the HMD 8n used by the user n performs processing similar to or same as the processing of Steps S53 to S55. Further, the terminal device 10B and the HMD 8B execute substantially the same processing as the processing of Steps S53 to S55 for the user n as well as for the user A.

In the above description, the processing of Steps S51 and S55 correspond to a step of displaying.

In the process described above, the generation unit 46 of the server 40 may execute processing similar to or same as the processing of Step S49, in alternative to the generation unit 15A of the terminal device 10A.

In such a case where the generation unit 46 of the server 40 executes the processing of Step 49, as described with reference to FIG. 10, in particular Steps S28 and S29, the generation unit 46 moves the viewpoint of the user A to the set movement destination and generates the input/output screen that displays the virtual space in which the avatar(s) of the other user(s) including the user B is (are) moved to the vicinity of the viewpoint of the user A at the movement destination, based on the information received in Step S48.

Subsequently, the transmission/reception unit 41 of the server 40 transmits input/output screen information indicating the generated input/output screen to the terminal device 10, and the communication unit 17 of the terminal device 10 transmits the input/output screen information received from the server 40 to the HMD 8, in substantially the same manner as in Step S50.

Further, the above-described processing can be executed in substantially the same manner even when the HMD 8A, the controller 20A, and the detection device 30A are not connected to the terminal device 10A.

The terminal device 10A detects whether the HMD 8A, the controller 20A, and the detection device 30A are connected, and when determining the devices are not connected, the terminal device 10A automatically selects the “terminal-screen mode” and executes the process.

With the “terminal-screen mode,” as described with reference to FIG. 10, in particular Steps S28 and S29, the generation unit 15A of the terminal device 10A generates the input/output screen that displays the virtual space corresponding to the viewpoint of the user A that is moved to the set movement destination and in which the avatar(s) of the other user(s) including the user B is (are) moved to the vicinity of the viewpoint of the user A at the movement destination, based on the multiple-participant movement operation performed by using, for example, the keyboard 110a or the mouse 110b.

Subsequently, in substantially the same manner as in Step S51, the display control unit 13A displays the generated input/output screen on the display 116a of the terminal device 10A. The input/output screen displayed on the display 116a of the terminal device 10A can be switched between the third person viewpoint and the first person viewpoint by, for example, an operation performed using the keyboard 110a or the mouse 110b.

In the process described above with reference to FIG. 11, the generation unit 46 of the server 40 may further execute processing similar to or same as the processing of Step S53, in alternative to the generation unit 15B of the terminal device 10B.

Further, the processing described with reference to FIG. 11 can be executed by the terminal device 10B with the “terminal screen mode,” in substantially the same manner even when the HMD 8B, the controller 20B, and the detection device 30B are not connected to the terminal device 10B.

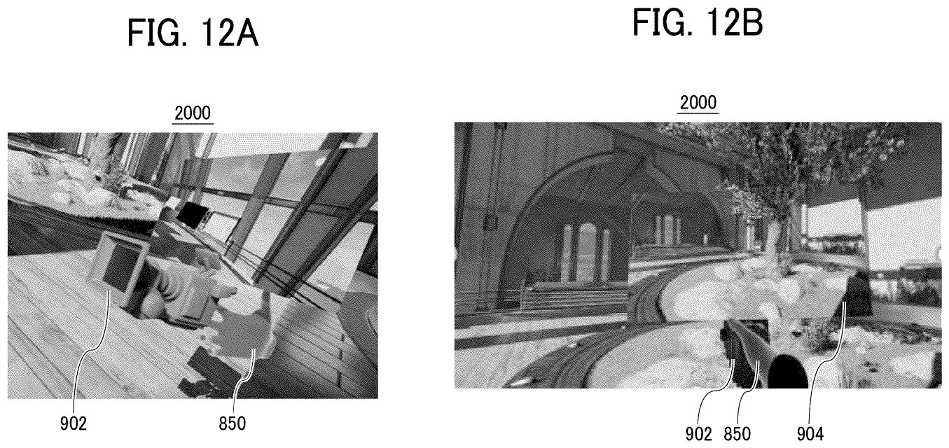

FIGS. 12A and 12B are diagrams each illustrating the input/output screen according to the present embodiment.

An input/output screen 2000 illustrated in FIG. 12A displays a virtual space including a camera 902 and a hand 850 of an avatar of a user.

The input/output screen 2000 illustrated in FIG. 12B displays the virtual space including a preview screen 904 of the camera 902 when the user operates the controller 20 to hold the camera 902 with the hand 850 of the avatar from the state illustrated in FIG. 12A.

When the user moves the controller 20 to move the camera 902 to change the field of view on the preview screen 904 and determines a position of the viewpoint to be registered, the user presses the trigger 24 of the controller 20 as an operation to press a shutter of a camera. Thereby, the configuring unit 18 sets the viewpoint position information indicating the position of the viewpoint illustrated on the preview screen 904, and the transmission/reception unit 11 transmits the set viewpoint position information to the server 40. As described with reference to FIG. 8A, the viewpoint position information includes the information items of preview image, space information including the position of the viewpoint, position information, direction information indicating the direction of the viewpoint, and angle of view information indicating the angle of view of the viewpoint.

The transmission/reception unit 41 of the server 40 receives the viewpoint position information transmitted from the terminal device 10, and the storing/reading unit 44 stores and registers the viewpoint position information received by the transmission/reception unit 41 in the viewpoint position information management DB 4002. At this time, the storing/reading unit 44 stores and registers the order of storing and registering the viewpoint position information received by the transmission/reception unit 41 in the viewpoint position information management DB 4002 as an initial value of the movement order.

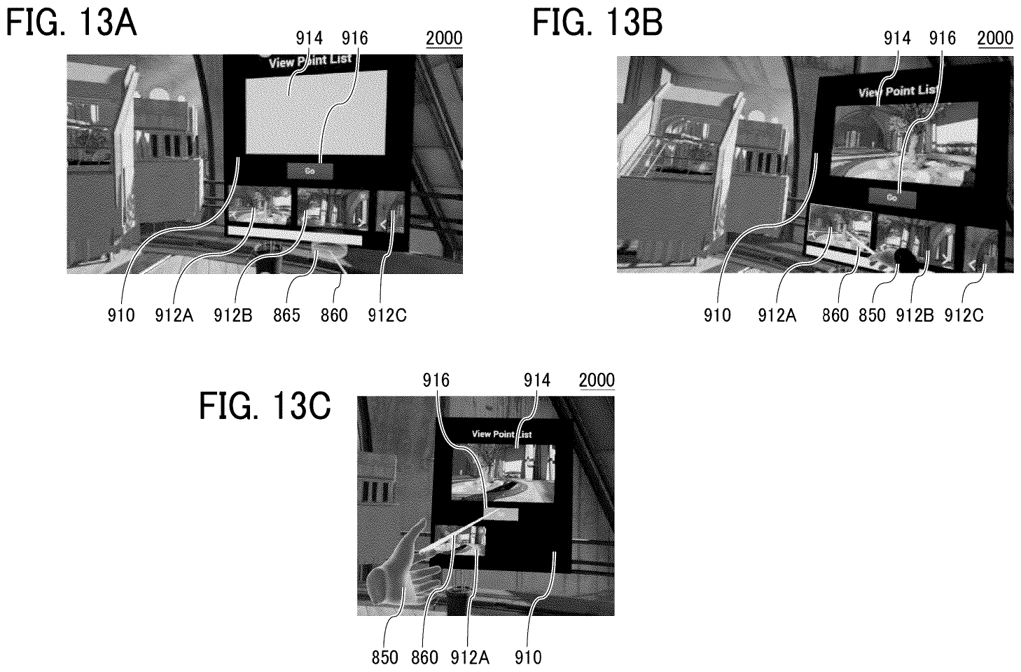

FIGS. 13A to 13C are diagrams each illustrating the input/output screen according to the present embodiment.

The input/output screen 2000 illustrated in FIG. 13A displays the virtual space including a laser 860 emitted from the hand of the avatar, a marker object 865 at an end of the laser, and a viewpoint selection screen 910.

The viewpoint selection screen 910 includes viewpoint screens 912A to 912C, a movement destination candidate screen 914, and a selection button 916. The viewpoint screens 912A to 912C are arranged in the movement order read from the viewpoint position information management DB 4002, and each displays a preview image for a corresponding position of the viewpoint read from the viewpoint position information management DB 4002.

The input/output screen 2000 illustrated in FIG. 13B displays the virtual space in a state in which the user moves the controller 20 to move the laser 860 from the state illustrated in FIG. 13A so that the laser 860 strikes the viewpoint screen 912A.

In this state, as described with reference to FIG. 10, in particular Step S22, the determination unit 16 determines that the viewpoint screen 912A is selected, and the generation unit 15 generates the input/output screen 2000 in which the viewpoint screen 912A is displayed in an enlarged manner on the destination candidate screen 914.

When a predetermined operation is performed by the user using the controller 20, the configuring unit 18 sets the movement order of the viewpoint screens 912A to 912C, and the transmission/reception unit 11 transmits information indicating the set movement order to the server 40 in association with the viewpoint identifiers.

The transmission/reception unit 41 of the server 40 receives information indicating the movement order transmitted from the terminal device 10, and the storing/reading unit 44 stores and registers the information, which is received by the transmission/reception unit 41, indicating the movement order in association with the viewpoint identifiers in the viewpoint position information management DB 4002.

The input/output screen 2000 illustrated in FIG. 13C displays the virtual space in a state in which the user moves the controller 20 to move the laser 860 from the state illustrated in FIG. 13B so that the laser 860 strikes the selection button 916.

In this state, the determination unit 16 determines that a single movement operation has been performed as described with reference to FIG. 10, in particular Step S25. On the other hand, when the user performs a predetermined operation with the controller 20 in the state illustrated in FIG. 13B, it is determined that a multiple-participant movement operation is performed as described with reference to FIG. 10, in particular Step S26.

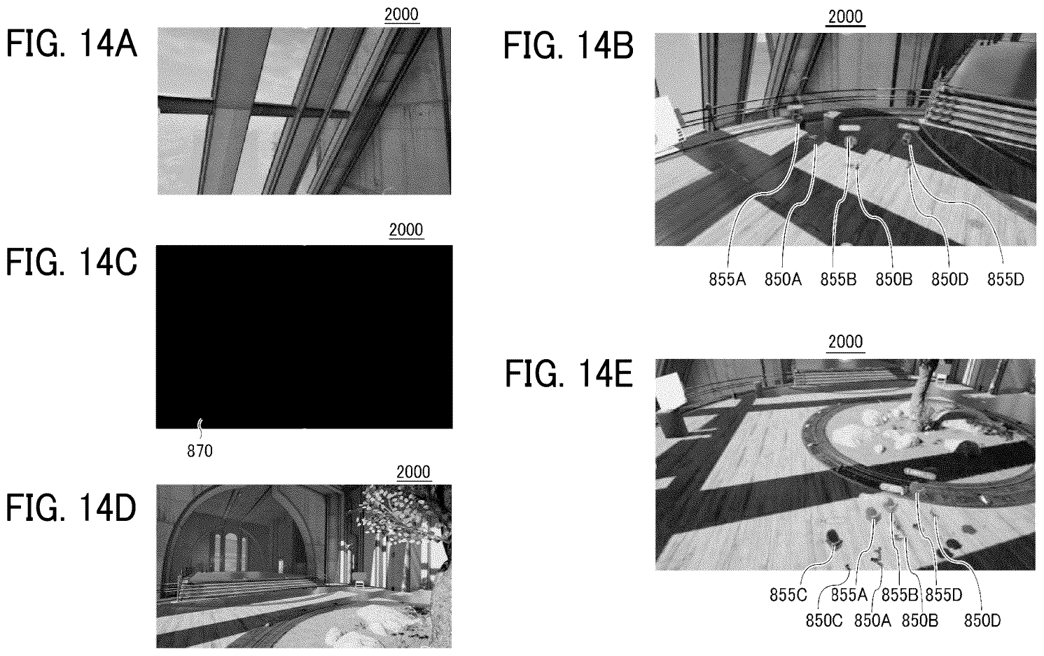

FIGS. 14A to 14E are diagrams each illustrating the input/output screen according to the present embodiment.

The input/output screen 2000 illustrated in FIG. 14A displays the virtual space from the first person viewpoint corresponding to the position of the viewpoint of the user A before the multiple-participant movement operation, which is described with reference to FIG. 10, in particular Step S25, is performed.

The input/output screen 2000 illustrated in FIG. 14B displays the virtual space from the viewpoint of the third person before the multiple-participant movement operation is performed, and includes a hand 850A and a head 855A of the avatar of the user A, a hand 850B and a head 855B of an avatar of the user B, and a hand 850D and a head 855D of an avatar of a user D.

The input/output screen 2000 illustrated in FIG. 14C displays a darkened image 870 in which the entire screen is darkened while the viewpoint is moved by the multiple-participant movement operation, from the state illustrated in FIG. 14A.

The input/output screen 2000 illustrated in FIG. 14D displays the virtual space in the first person viewpoint according to the position of the viewpoint of the user A after the viewpoint is moved by the multiple-participant movement operation from the state illustrated in FIG. 14A. In the description of the present embodiment, the virtual space of the input/output screen 2000 illustrated in FIG. 14D corresponds to a space, specifically, in another room, being outside the field of view of the virtual space of the input/output screen 2000 illustrated in FIG. 14A.

The input/output screen 2000 illustrated in FIG. 14E displays the virtual space at the third person viewpoint after the viewpoint is moved from the state illustrated in FIG. 14B by the multiple-participant movement operation, and similarly to the input/output screen 2000 illustrated in FIG. 14B, includes the hand 850A and the head 855A of the avatar of the user A, the hand 850B and head 855B of the avatar of the user B, the hand 850D and head 855D of the avatar of the user D, and further includes a hand 850C and a head 855C of an avatar of a user C. In the description of the present embodiment, the virtual space of the input/output screen 2000 illustrated in FIG. 14E corresponds to a space, specifically, in another room, being outside the field of view of the virtual space of the input/output screen 2000 illustrated in FIG. 14E.

In the states illustrated in FIGS. 14D and 14E, when any one of the users A to D performs a multiple-participant movement operation, all the viewpoints of the users A to D are to be moved to the vicinity of the position of the viewpoint of the next movement position in the movement order based on the information indicating the movement order stored in the viewpoint position information management DB 4002, in substantially the same manner as in FIGS. 14C to 14E.

As illustrated in FIG. 14E, the generation unit 15 generates the input/output screen 2000 that displays the virtual space corresponding to the viewpoint of the user A that is moved in response to the multiple-participant movement operation performed by the user A. Accordingly, the user A can move his or her viewpoint to a desired position in the virtual space.

When the viewpoint of the user A is moved to a space outside the field of view by the multiple-participant movement operation of the user A, the generation unit 15 generates the input/output screen 2000 that displays the virtual space in which the hands 850B to 850D and the heads 855B to 855D of the avatars of the other users B to D are moved to the vicinity of the viewpoint of the user A.

Accordingly, the viewpoints of the multiple users A to D are gathered at the movement destination outside the field of view in the virtual space, based on the multiple-participant movement operation performed by the user A with the terminal device 10A, and the tour function involving the multiple users can be implemented.

Further, the user A can recognize that the avatars of the multiple users B to D, namely, the viewpoints, are gathered, by checking the left and right on the input/output screen 2000 illustrated in FIG. 14D.

In the description of the present embodiment, as described above with reference to FIGS. 13A and 13B, the movement destination outside the field of view is a space in the viewpoint selected from the viewpoint screens 912A to 921C indicating multiple candidates. Accordingly, the viewpoints of the multiple users can be gathered at the movement destination that is outside the field of view and that is selected from among the multiple candidates in the virtual space. The position at which the viewpoints of the multiple users are gathered is not limited to the viewpoint position information registered in the viewpoint position information management DB 4002, and may be the position of the viewpoint of the user A at the time when the user A performs the multiple-participant movement operation.

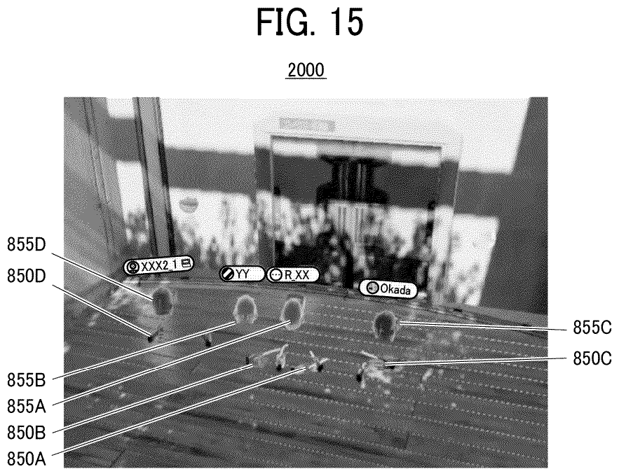

FIG. 15 is a diagram illustrating details of the input/output screen 2000 illustrated in FIG. 14E.

As illustrated in FIG. 15, the hand 850A and the head 855A of the avatar of the user A, the hand 850B and the head 855B of the avatar of the user B, the hand 850C and the head 855C of the avatar of the user C, and the hand 850D and the head 855D of the avatar of the user D are arranged in the same direction in a predetermined order so as not to overlap each other in the virtual space after the movement.

In other words, the generation unit 15 generates the input/output screen 2000 that displays the virtual space in which the viewpoints of the users B to D are moved in a predetermined positional relationship with respect to the viewpoint of the user A who has performed the multiple-participant movement operation.

For example, the viewpoints of the users B to D may be arranged at a position having a predetermined distance from each other in the order of logging in and participating in the display system 1 around the viewpoint of the user A who has performed the multiple-participant movement operation, such as in the order of participation, arranging the participants to the left of the user A, to the right of the user A, to the left of a participant previously positioned to the left of the user A, and to the right of another participant previously positioned to the right of the user A. For example, the viewpoint of a specific user may be arranged at a specific position such as the left of the viewpoint of a user who has performed the multiple-participant movement operation. The order of arrangement may be changed. For example, based on the authority of the user, the viewpoints may be arranged in the order of the guest, the general, and the administrator from a position that is closest to the registered viewpoint.

As described above, the viewpoints of the multiple users can be gathered in the virtual space in a predetermined positional relationship.

Further, the generation unit 15 generates the input/output screen 2000 that displays the hands 850B to 850D and the heads 855B to 855D of the avatars of the users B to D at positions corresponding to the viewpoints of the users B to D, and displays the virtual space corresponding to the viewpoint of the user A who has performed the multiple-participant movement operation, in a manner that the viewpoint of the user A does not overlap with the other avatars. In other words, the viewpoints and the avatars of the users B to D are arranged at the positions each having a distance from the viewpoint of the movement destination of the user A within a range in which a field of view from the viewpoint of the movement destination of the user A can be shared.

Accordingly, when the viewpoints of the multiple users are gathered in the virtual space, the avatars of the users B to D can be displayed without being overlapped with the viewpoint of the user A who has performed the multiple-participant movement operation. If the viewpoints overlap with each other, the distance between an avatar of a user from another avatar of another user is too short, and the personal space in the virtual space is affected and the user feels uncomfortable. For this reason, the viewpoints are arranged to prevent overlap with each other. On the other hand, it is also possible to arrange the viewpoints to be overlapped with each other, and in such a case in which another avatar of another user is placed by having little distance from the avatar or the user, the other avatar of the other user may be hidden to reduce feeling of the user of discomfort.

Further, the generation unit 15 generates the input/output screen 2000 that displays the virtual space corresponding to the viewpoint of the user A who has performed the multiple-participant movement operation, in a manner that the viewpoint of user A faces the same direction as the viewpoints of the users B to D. Accordingly, the tour function for gathering the viewpoints of the multiple users in the virtual space and causing a field of view to be shared by the multiple users can be implemented.

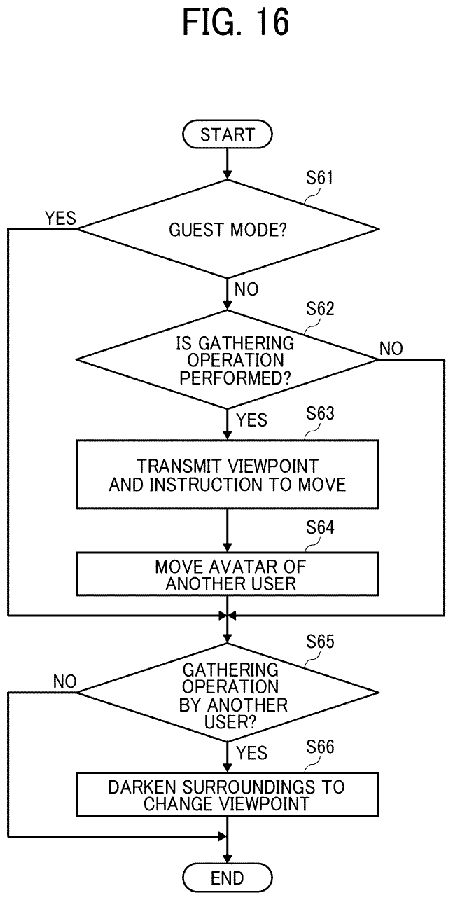

FIG. 16 is a flowchart of a process for a gathering operation according to the present embodiment.

The determination unit 16 of the terminal device 10 determines whether the authority of the user is guest based on the user information stored in the user information management DB 4003 (Step S61), and when the authority of the user is guest, the process proceeds to Step S65.

When the determination in Step S61 indicates that the authority of the user is not guest, the determination unit 16 determines whether a gathering operation is performed by the user, based on the operation information received from the controller 20 by the communication unit 17 (Step S62), and when the gathering operation is not performed, the process proceeds to Step S65.

When the gathering operation is performed in Step S62, the transmission/reception unit 11 transmits, to the server 40, the viewpoint position information indicating the position of the viewpoint of the user and the instruction information instructing to move a viewpoint of another user, or one or more viewpoints of the other one or more users, to the vicinity of the viewpoint of the user (Step S63).

Further, the generation unit 15 generates an input/output screen that displays the virtual space in which an avatar of the other user, or one or more avatars of the other one or more users is or are moved to the vicinity of the viewpoint of the user (Step S64).

Accordingly, the user can cause the viewpoint of the other user, or the viewpoints of the other one or more users, to move to the vicinity of the viewpoint of the user in the virtual space, and thus can cause the other user(s) to participate in the tour started by the user.

The determination unit 16 determines whether the transmission/reception unit 11 has received additional viewpoint position information indicating a position of a viewpoint of another user and additional instruction information instructing to move the viewpoint of the user to the vicinity of the viewpoint of the other user (Step S65).

When the determination in Step S65 indicates that the information is received, the generation unit 15 darkens the surroundings of the viewpoint or the entire screen, and generates the input/output screen corresponding to the viewpoint of the user that is moved to the vicinity of the position of the viewpoint of the other user received in Step S65 (Step S66). Accordingly, the user can move his or her viewpoint to the vicinity of the viewpoint of the other user in the virtual space, and thus can participate in a tour started by the other user.

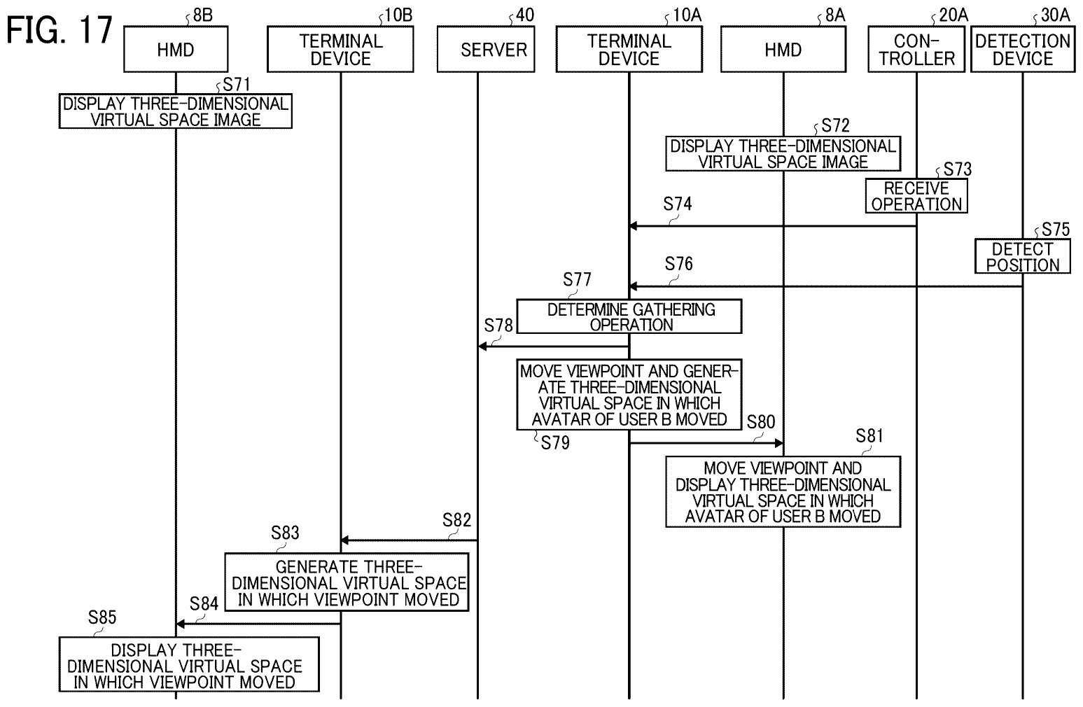

FIG. 17 is a sequence diagram illustrating a process for a gathering operation according to the present embodiment.

The display control unit 82B of the HMD 8B used by the user B causes the display units 808RB and 808LB to display an input/output screen that displays a virtual space corresponding to a position of a viewpoint of the user B (Step S71), and the display control unit 82A of the HMD 8A used by the user A also causes the display units 808RA and 808LA to display an input/output screen that displays the virtual space corresponding to a position of a viewpoint of the user A (Step S72). When another user n other than the users A and B also participates in the display system 1, the display control unit 82n of the HMD 8n used by the user n also causes the display units 808Rn and 808Ln to display an input/output screen that displays the virtual space.

The reception unit 22A of the controller 20A used by the user A receives various one or more operations that are performed by the user and described above with reference to FIG. 2 (Step S73).

The communication unit 21A transmits operation information indicating the operation received in Step S73 to the terminal device 10A, and the communication unit 17A of the terminal device 10A receives the operation information transmitted from the controller 20A (Step S74).

The detection unit 32A of the detection device 30A used by the user A detects the positions and tilts of the HMD 8A and the controller 20A (Step S75).

The communication unit 31A transmits detection information indicating the information detected in Step S75 to the terminal device 10A, and the communication unit 17A of the terminal device 10A receives the detection information transmitted from the detection device 30A (Step S76).

The determination unit 16A determines whether a gathering operation is performed by the user A, based on the operation information received from the controller 20A by the communication unit 17A (Step S77).

When it is determined that the gathering operation is performed in Step S77, the transmission/reception unit 11A transmits, to the server 40, the viewpoint position information indicating the position of the viewpoint of the user A and the instruction information instructing to move the one or more viewpoints of the other users including the user B to the vicinity of the viewpoint of the user A, and the transmission/reception unit 41 of the server 40 receives the information (Step S78).

The generation unit 15A generates the input/output screen that displays the virtual space in which an avatar of another user, or one or more avatars of the other one or more uses, including the user B is or are moved to the vicinity of the viewpoint of the user A (Step S79).

The communication unit 17A of the terminal device 10A transmits input/output screen information indicating the input/output screen generated in Step S79 to the HMD 8A, and the communication unit 88A of the HMD 8A receives the input/output screen information transmitted from the terminal device 10A (Step S80).

The display control unit 82A causes the display units 808RA and 808LA to display the input/output screen represented by the input/output screen information received in Step S80 (Step S81). The processing of Step S81 corresponds to a step of displaying.

Further, the transmission/reception unit 41 of the server 40 transmits the viewpoint position information of the user A and the instruction information received from the terminal device 10A in Step S78 to the terminal device 10B used by the user B, and the transmission/reception unit 11B of the terminal device 10B receives the information (Step S82).

When the user n other than the users A and B also participates in the display system 1, the transmission/reception unit 41 of the server 40 transmits the viewpoint position information of the user A and the instruction information received from the terminal device 10A in Step S78 to the terminal device 10n used by the user n, and the transmission/reception unit 11n of the terminal device 10n receives the information.

In substantially the same manner, the transmission/reception unit 41 of the server 40 transmits additional viewpoint position information of the user n and additional instruction information received from the terminal device 10n to the terminal device 10B used by the user B, and the transmission/reception unit 11B of the terminal device 10B receives the information.

As described with reference to FIG. 16, in particular Step S66, the generation unit 15B generates the input/output screen that displays the virtual space corresponding to the viewpoint of the user B that is moved to the vicinity of the viewpoint of the user A (Step S83).

The communication unit 17B of the terminal device 10B transmits input/output screen information representing the input/output screen generated in Step S83 to the HMD 8B, and the communication unit 88B of the HMD 8B receives the input/output screen information transmitted from the terminal device 10B (Step S84).

The display control unit 82B causes the display units 808RB and 808LB to display the input/output screen represented by the input/output screen information received in Step S84 (Step S85). The processing of Step S85 corresponds to a step of displaying.

When the user n other than the users A and B also participates in the display system 1, the terminal device 10n and the HMD 8n used by the user n performs processing similar to or same as the processing of Steps S83 to S85. Further, the terminal device 10B and the HMD 8B execute processing similar to or same as the processing of Steps S83 to S85 for the user n as well as for the user A.

In the process described above with reference to FIG. 17, in substantially the same manner as FIG. 11, the generation unit 46 of the server 40 may further execute processing similar to or same as the processing of Step S79, in alternative to the generation unit 15A of the terminal device 10A or processing similar to or same as the processing of Step S83 in alternative to the generation unit 15B of the terminal device 10B.

Further, the processing described with reference to FIG. 17 can be executed by the terminal device 10A with the “terminal screen mode,” in substantially the same manner even when the HMD 8A, the controller 20A, and the detection device 30A are not connected to the terminal device 10A, in substantially the same manner as FIG. 11. Further, the processing described with reference to FIG. 17 can be executed by the terminal device 10B with the “terminal screen mode,” in substantially the same manner even when the HMD 8B, the controller 20B, and the detection device 30B are not connected to the terminal device 10B, in substantially the same manner as FIG. 11.

It has been difficult to determine positions of viewpoints of multiple users, especially when the multiple users are close to one another such as in the case of touring.

According to one or more embodiments of the present disclosure, positions of viewpoints of multiple users can be associated with each other in a virtual space.

### Aspect 1

As described above, the terminal device 10 according to an embodiment of the present disclosure includes the generation unit 15 to generate the input/output screen 2000 that displays a virtual space corresponding to a position of a viewpoint of a user and that displays the virtual space corresponding to the viewpoint of the user that is moved to the vicinity of another viewpoint of another user in response to an operation performed by the other user. The terminal device 10 serves as an information processing apparatus, the input/output screen 2000 serves as a display screen, and the generation unit 15 serves as a display screen generation unit.

Accordingly, the tour function for gathering the positions of the viewpoints of the multiple users in association with each other in the virtual space and for causing a field of view to be shared by the multiple users can be implemented.

### Aspect 2

In Aspect 1, the terminal device 10B includes the transmission/reception unit 11 to receive viewpoint position information indicating a position of a viewpoint of the other user A and instruction information instructing to move the viewpoint of the user B to the vicinity of the viewpoint of the other user A. The viewpoint position information and the instruction information are transmitted from the terminal device 10A that serves as an external apparatus based on the operation performed by the other user A. Based on the viewpoint position information and the instruction information received by the transmission/reception unit 11, the generation unit 15 generates the input/output screen 2000 that displays the virtual space corresponding to the viewpoint of the user B that is moved to the vicinity of the other viewpoint.

Accordingly, the viewpoints of the multiple users can be gathered in the virtual space in response to the operation performed by the other user A with the terminal device 10A.

### Aspect 3

In any one of Aspect 1 and Aspect 2, in a case where the other viewpoint moves, the generation unit 15 generates the input/output screen 2000 that displays the virtual space corresponding to the viewpoint of the user A that is moved to the vicinity of the other viewpoint after movement of the other viewpoint.

Accordingly, the viewpoints of the multiple users can be gathered at a predetermined movement destination in the virtual space.

### Aspect 4

In Aspect 3, in a case where the other viewpoint moves to a space outside the field of view, the generation unit 15 generates the input/output screen 2000 that displays the virtual space corresponding to the viewpoint of the user that is moved to the vicinity of the other viewpoint after movement of the other viewpoint.

Accordingly, the viewpoints of the multiple users can be gathered at a movement destination that is outside the field of view in the virtual space.

Further, in a case where the other viewpoint is moved to a position within the field of view, the generation unit 15 may generate the input/output screen 2000 that displays the virtual space corresponding to the viewpoint of the user that is moved to the vicinity of the other viewpoint after movement of the other viewpoint. Specifically, when the other viewpoint is moved by any one of the laser point movement, the transparent movement, the forward/backward movement, the upward/downward movement, the push-in movement, and the grip movement described with reference to FIG. 2, the generation unit 15 may generate the input/output screen 2000 that displays the virtual space corresponding to the viewpoint that is moved to the vicinity of the other viewpoint after movement of the other viewpoint.

### Aspect 5

In Aspect 4, in a case where the other viewpoint moves to a space that is outside the field of view and selected from among multiple candidates, the generation unit 15 generates the input/output screen 2000 that displays the virtual space corresponding to the viewpoint of the user that is moved to the vicinity of the other viewpoint after movement of the other viewpoint.

Accordingly, the viewpoints of the multiple users can be gathered at a movement destination that is outside the field of view and that is selected from among the multiple candidates in the virtual space.

### Aspect 6

In any one of Aspect 1 to Aspect 5, the generation unit 15 generates the input/output screen 2000 that displays the virtual space corresponding to the viewpoint of the user that is moved so as to face the same direction as the other viewpoint.

Accordingly, the tour function for gathering the viewpoints of the multiple users in the virtual space and for causing a field of view to be shared by the multiple users can be implemented.

### Aspect 7

In any one of Aspect 1 to Aspect 6, the generation unit 15 generates the input/output screen 2000 that displays the virtual space corresponding to the viewpoint of the user that is moved to establish a predetermined positional relationship with the other viewpoint.

Accordingly, the viewpoints of the multiple users can be gathered in the virtual space in the predetermined positional relationship.

### Aspect 8

In Aspect 7, the generation unit 15 generates the input/output screen 2000 that displays the virtual space in which an avatar of the other user is displayed at a position corresponding to the other viewpoint and the viewpoint of the user is moved so as not to overlap with the avatar.

Accordingly, when the viewpoints of multiple users are gathered in the virtual space, the own viewpoint is prevented from being overlapped with one or more of the avatars of the other users.

### Aspect 9

In any one of Aspect 1 to Aspect 8, the generation unit 15 generates the input/output screen 2000 that displays the virtual space corresponding to the viewpoint of the user that is moved in response to an operation of the user.

Accordingly, the own viewpoint can be moved to the vicinity of the viewpoint of the other user in the virtual space, and the own viewpoint also can be moved to a desired position in the virtual space.

### Aspect 10

In any one of Aspect 1 to Aspect 9, the terminal device 10A includes the transmission/reception unit 11 to transmit viewpoint position information indicating a position of the viewpoint of the user A and instruction information instructing to move the viewpoint of the other user B to the vicinity of the viewpoint of the user A to the terminal device 10B that generates an input/output screen 2000B displaying the virtual space corresponding to a position of the viewpoint of the other user B.

Accordingly, the own viewpoint can be moved to the vicinity of the viewpoint of the other user in the virtual space, and the viewpoint of the other user also can be moved to the vicinity of the own viewpoint.

### Aspect 11

As described above, the terminal device 10 according to an embodiment of the present disclosure includes the generation unit 15 to generate the input/output screen 2000 that displays a virtual space corresponding to a position of a viewpoint of a user and that displays the virtual space in which an avatar of another user is moved to the vicinity of the viewpoint of the user in response to an operation performed by the user.

Accordingly, the avatars of the other users can be moved to the vicinity of the own viewpoint in the virtual space, so that gathering the viewpoints of the other users can be recognized.

### Aspect 12

An information processing method according to an embodiment of the present disclosure includes generating the input/output screen 2000 that displays a virtual space corresponding to a position of a viewpoint of a user and that displays the virtual space corresponding to the viewpoint of the user that is moved to the vicinity of another viewpoint of another user in response to an operation performed by the other user.

### Aspect 13

An information processing method according to an embodiment of the present disclosure includes generating the input/output screen 2000 that displays a virtual space corresponding to a position of a viewpoint of a user and that displays the virtual space in which an avatar of another user is moved to the vicinity of the viewpoint of the user in response to an operation performed by the user.

### Aspect 14

An information processing method according to an embodiment of the present disclosure includes displaying a virtual space corresponding to a position of a viewpoint of a user and corresponding to the viewpoint of the user that is moved to the vicinity of another viewpoint of another user in response to an operation performed by the other user.

### Aspect 15

An information processing method according to an embodiment of the present disclosure includes displaying a virtual space corresponding to a position of a viewpoint of a user and in which an avatar of another user is moved to the vicinity of the viewpoint of the user in response to an operation performed by the user.

### Aspect 16

A program according to an embodiment of the present disclosure causes a computer to execute the information processing method according to any one of Aspect 12 to Aspect 15.

### Aspect 17

The display system 1 serving as an information processing system according to an embodiment of the present disclosure includes the terminal device 10A serving as a first information processing apparatus and the terminal device 10B serving as a second information processing apparatus. The terminal device 10A and the terminal device 10B can communicate with each other. The terminal device 10A includes the first generation unit 15A to generate a first input/output screen 2000A that displays a first virtual space corresponding to a position of a viewpoint of a first user A and in which an avatar of a second user B is moved to the vicinity of the viewpoint of the first user A in response to an operation performed by the first user A, and the transmission/reception unit 11A to transmit, to the terminal device 10B, first viewpoint position information indicating the position of the viewpoint of the first user A and instruction information for instructing to move a viewpoint of the second user B to the vicinity of the viewpoint of the first user A. The terminal device 10B includes the transmission/reception unit 11B to receive the first viewpoint position information and the instruction information transmitted from the terminal device 10A, and the second generation unit 15B to generate a second input/output screen 2000B that displays a second virtual space corresponding to a viewpoint of the second user B and displays the second virtual space corresponding to the viewpoint of the second user B that is moved to the vicinity of the viewpoint of the first user A based on the first viewpoint position information and the instruction information received by the transmission/reception unit 11B.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application specific integrated circuits (ASICs), digital signal processors (DSPs), field programmable gate arrays (FPGAs), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

1. An information processing apparatus, comprising
circuitry configured to
generate a display screen that:
displays a virtual space corresponding to a viewpoint of a user; and
displays, in response to an operation performed by another user, the virtual space corresponding to the viewpoint that is moved to vicinity of another viewpoint of the another user.

2. The information processing apparatus of claim 1, wherein
the circuitry is further configured to:
receive viewpoint position information that is information on a position of the another viewpoint of the another user and instruction information instructing to move the viewpoint of the user to the vicinity of the another viewpoint of the another user, the viewpoint position information and the instruction information being transmitted from an external apparatus external to the information processing apparatus in response to the operation performed by the another user, and
the display screen that displays the virtual space corresponding to the viewpoint that is moved to the vicinity of the another viewpoint is generated based on the viewpoint position information and the instruction information.

3. The information processing apparatus of claim 1, wherein, in a case that the another viewpoint moves, the circuitry is configured to:
generate the display screen that displays the virtual space corresponding to the viewpoint that is moved to the vicinity of the another viewpoint after movement of the another viewpoint.

4. The information processing apparatus of claim 3, wherein
the movement of the another viewpoint is movement to a space outside of a field of view.

5. The information processing apparatus of claim 4, wherein
space outside of the field of view is selected from among a plurality of candidates.

6. The information processing apparatus of claim 1, wherein the circuitry is configured to:
generate the display screen that displays the virtual space corresponding to the viewpoint that is moved to face a same direction as the another viewpoint.

7. The information processing apparatus of claim 1, wherein the circuitry is configured to:
generate the display screen that displays the virtual space corresponding to the viewpoint that is moved to establish a specific positional relationship with the another viewpoint.

8. The information processing apparatus of claim 7, wherein the circuitry is configured to:
generate the display screen that displays the virtual space in which an avatar of the another user is displayed at a position corresponding to the another viewpoint, and displays the virtual space corresponding to the viewpoint that is moved such that the viewpoint of the user is prevented from overlapping with the position of the avatar.

9. The information processing apparatus of claim 1, wherein the circuitry is configured to:
generate the display screen that displays the virtual space corresponding to the viewpoint that is moved in response to an additional operation performed by the user.

10. The information processing apparatus of claim 1, wherein the circuitry is further configured to:
transmit, to another external apparatus, viewpoint position information that is information on a position of the viewpoint of the user and instruction information for instructing to move the another viewpoint of the another user to vicinity of the viewpoint of the user, causing the another external apparatus to generate another display screen displaying the virtual space corresponding to the another viewpoint of the another user.

11. The information processing apparatus of claim 1, wherein the circuitry is configured to:
generate the display screen that displays the virtual space in which an avatar of the another user is moved to vicinity of the viewpoint of the user in response to an additional operation performed by the user.

12. An information processing method, comprising:
generating a display screen that:
displays a virtual space corresponding to a viewpoint of a user; and
displays, in response to an operation performed by another user, the virtual space corresponding to the viewpoint that is moved to vicinity of another viewpoint of the another user.

13. The information processing method of claim 12, wherein the generating includes:
generating the display screen that displays the virtual space in which an avatar of the another user is moved to vicinity of the viewpoint of the user in response to an additional operation performed by the user.

14. The information processing method of claim 12, further comprising:
displaying the virtual space.

15. The information processing method of claim 13, further comprising:
displaying the virtual space.

16. An information processing system, comprising:
a first information processing apparatus; and
a second information processing apparatus communicably connected to the first information processing apparatus,
the first information processing apparatus being configured to:
generate a first display screen that displays a first virtual space corresponding to a first viewpoint of a first user, and displays the first virtual space in which an avatar of a second user is moved to vicinity of the first viewpoint in response to an operation performed by the first user; and
transmit, to the second information processing apparatus, first viewpoint position information that is information on a position of the first viewpoint and instruction information for instructing to move a second viewpoint of the second user to the position of the first viewpoint, and the second information processing apparatus being configured to:
receive the first viewpoint position information and the instruction information transmitted from the first information processing apparatus; and
generate a second display screen that displays a second virtual space corresponding to the second viewpoint, and displays the second virtual space corresponding to the second viewpoint that is moved to the vicinity of the first viewpoint based on the first viewpoint position information and the instruction information.
